(19) United States
(12) Patent Application Publication
(10) Pub. No.: US 2006/0122814 A1
(43) Pub. Date: Jun. 8, 2006

(54) Method and apparatus for digital signal processing analysis and development

(76) Inventors: Jason A. Beens, San Antonio, TX (US); Scott R. Hinson, Austin, TX (US); Daniel E. Nesthus, San Antonio, TX (US)

Correspondence Address: Michelle L. Evans;Gunn & Lee, P.C., Suite 1500, 700 N. St. Mary's, San Antonio, TX, 78205, US

(21) Appl. No.: 11/291,538

(22) Filed: Dec. 1, 2005

Related U.S. Application Data
(60) Provisional application No. 60/633,178, filed on Dec. 3, 2004.

(51) Int. Cl. G06F 15/00

(52) U.S. Cl. 702/189

(57) ABSTRACT

A method and apparatus for digital signal processing (DSP) is provided having a main processor system (MPS) connected through a bridge to digital signal processing hardware (DSPH). MPS has a processor subsystem which receives input from input devices. Processor subsystem interfaces to display subsystem which presents information to a user through a graphical user interface. DSPH has generic logic resources (GLR) which implement the DSP and a digital signal processing system (DSPS) circuitry which supports the DSP functions. This circuitry includes memory and optionally additional microprocessor(s). Bridge circuitry is also included to implement the client portion of the bridge. The DSPS connects to high speed input output (HSIO) ports, to a digital to analog converter (DAC), and an analog to digital converter (ADC). Add-on modules (AOM) which contain circuitry which extends the capabilities of the DSPS may be connected to the DSPS, ADC, and DAC through the HSIO ports.

This application claims priority to U.S. Provisional Application Ser. No. 60/633,178 filed Dec. 3, 2004.

### BACKGROUND OF THE INVENTION

1. Field of the Invention

Applicant's invention relates to a method and apparatus that will assist in the development and analysis of digital signal processing (DSP) systems.

2. Background Information

The present invention applies a significantly different approach to DSP development than the industry currently embraces. This new approach stems from leveraging the technologies enabled by DSP to assist in DSP development, instead of relying on those technologies which existed prior to the boom of DSP development seen in recent years. In the past, DSP development efforts relied upon equipment such as logic analyzers, vector signal analyzers, spectrum analyzers, modulation analyzers, and oscilloscopes to gain information about the performance of system components. These equipments were used because they were readily available, but they possess inherent limitations which are evident when they are applied to DSP design. One significant limitation stems from the need for current test equipment, with the exception of logic analyzers, to receive input in the form of analog signals, which may mask the performance of the digital system under development. With respect to communications, which represents a significant portion of the DSP marketplace, current equipment for modulation and demodulation of signals suffer this limitation. Few options are available for digital designers to view digital signals in their native digital format. Logic analyzers are capable of capturing digital signal states at discrete times, and then displaying them for the designer to interpret, but these devices suffer from the inability to process digital data beyond simple signal groupings, math, or time domain displays.

There is a need to address these shortcomings, and aid DSP development. The present invention not only consolidates existing technology, but it improves upon the interface to make a new technology which is more suited to development with DSP allowing designers to interact with their designs in new ways. In its simplest form, the invention allows DSP designers to make measurements on digital signals as if they were analog signals. This is accomplished without the need for conversion from digital to analog at the designer's device output, and the conversion from analog to digital in the target equipment. By dealing with DSP signals in their native digital form, the digital designer can now measure and quantify the performance of a system, or a system component individually. This type of analysis has not been possible in real-time or near real-time, until now. For example, a pulse shaping filter which is commonly used in digital signal transmission is designed to produce a particular spectrum, but this spectrum cannot be displayed without connecting the filter to a spectrum analyzer. Here the limitations of the spectrum analyzer may influence the measurement of the pulse shaping filter, because the spectrum analyzer requires the output of the filter to be translated to a frequency within the spectrum analyzer's pass band. Additionally the spectrum analyzer requires the digital filter output to be converted into an analog format compatible with the spectrum analyzer. The spectrum analyzer will then display the result of the pulse shaping filter, the frequency translation process, the digital to analog conversion process, and any noise introduced in these processes. The result is a system which is unable to display the performance of the filter alone. The present invention would be able to produce the resultant frequency display, similar to the spectrum analyzer, but it would not require the frequency translation or conversion steps between analog and digital. This allows the present invention to produce an accurate representation of the filter's performance by itself.

### SUMMARY OF THE INVENTION

The preferred embodiment of the present invention includes configurable high-speed generic logic resources (GLR) which may implement most DSP systems. These chains are terminated in high-speed input output (HSIO) ports which may be connected to other pieces of digital equipment, digital printed circuit assemblies, or even analog equipment through the use of purpose specific add-on modules (AOM). The HSIO ports are exposed to the user to allow interfacing of the user's equipment to the invention.

A main processor system (MPS) is provided which controls the overall system configuration. Within the MPS, a processor subsystem receives user input from input device(s). The processor subsystem also interfaces to a display subsystem which presents information to the user through a graphical user interface (GUI). The MPS connects to the digital signal processing hardware (DSPH) through a bridge. The DSPH consists of GLR which can be configured to implement digital signal processing functions. In addition to the GLR, the DSPH also contains circuitry for support of DSP functions which collectively is referred to as the digital signal processing system (DSPS). This circuitry includes memory and optionally additional microprocessor(s). Bridge circuitry is also included to implement the client portion of the bridge. The DSPS connects to the HSIO ports, to a digital to analog converter (DAC), and an analog to digital converter (ADC). Add-on modules may be connected to the DSPS, ADC, and DAC through the HSIO ports. The AOMs contain circuitry which extends the capabilities of the digital signal processing system, and tailors the electrical interface of the invention to satisfy the user's requirements. The DSPH is configured by the MPS to perform any signal processing task within the capabilities of the DSPH.

### BRIEF DESCRIPTION OF THE DRAWINGS

FIG. 1 is a block diagram of the preferred embodiment of the present invention.

FIG. 2 is a block diagram of prior art connection of spectrum analyzer to device under test (DUT).

FIG. 3 is a block diagram of prior art logic analyzer connected to device under test (DUT).

FIG. 4 is a block diagram of the preferred embodiment of the present invention measuring characteristics of digital signal process A in device under test (DUT).

FIG. 5 is a block diagram of the preferred embodiment of the present invention configured as inline development with user supplied hardware and software.

FIG. 6 is a block diagram of the preferred embodiment of the present invention configured for inline development with user supplied software.

FIG. 7. is a block diagram of the prior art inline development of user hardware and software.

FIG. 8 is a block diagram of the prior art representation of digital data captured with logic analyzer.

FIG. 9 is a block diagram of digital data obtained from the preferred embodiment of the present invention.

FIG. 10 is a block diagram showing examples of interdependencies of system elements based on choice of mode and configuration for the preferred embodiment of the present invention.

FIG. 11 is a block diagram of a probe interface ad on module for the preferred embodiment of the present invention.

FIG. 12 is a block diagram of an add on module for field programmable gate array (FPGA) DSP development platform of the preferred embodiment of the present invention.

FIG. 13 is a block diagram of the add on module for DSP processor development platform for the preferred embodiment of the present invention.

FIG. 14 is a block diagram of an add on module for RF interface for the preferred embodiment of the present invention.

FIG. 15 is a block diagram of an add on module for electronics development for the preferred embodiment of the present invention.

FIG. 16 is a block diagram of the software system architecture showing data flow of the preferred embodiment of the present invention.

FIG. 17 is a block diagram of the digital signal processing system (DSPS) architectural components for the preferred embodiment of the present invention.

FIG. 18 is a block diagram of a sample interface DSPS to HSIO for the preferred embodiment of the present invention.

FIG. 19 is a block diagram of a sample practical DSPS system showing blocks, ports, and hardware interfaces for the preferred embodiment of the present invention.

FIG. 20 is a block diagram showing a sample configuration of the digital signal processing hardware (DSPH) for a quadrature transmitter system for the preferred embodiment of the present invention.

FIG. 21 is a block diagram showing a sample configuration of generic logic for quatrature receiver system for the preferred embodiment of the present invention.

FIG. 22 is a block diagram of the channel simulator for the preferred embodiment of the present invention.

FIG. 23 is a graph showing the clipping impairment transfer function for the preferred embodiment of the present invention.

FIG. 24 is a block diagram showing the clipping impairment for the preferred embodiment of the present invention.

FIG. 25 is a block diagram showing a sample broadband noise generator for the preferred embodiment of the present invention.

FIG. 26 is a block diagram of a burst noise simulator for the preferred embodiment of the present invention.

FIG. 27 is a block diagram of the digital signal processing hardware (DSPH) configuration for the spectrum analyzer of the preferred embodiment of the present invention.

FIG. 28 is a graph showing a sample display output in spectrum analyzer mode for the preferred embodiment of the present invention.

FIG. 29 is a block diagram of the configuration of the DSPH for oscilloscope mode for the preferred embodiment of the present invention.

FIG. 30 is a block diagram of the configuration of DSPH for logic analyzer mode for the preferred embodiment of the present invention.

FIG. 31 is a block diagram of the configuration of DSPH for arbitrary waveform generator (AWG) for the preferred embodiment of the present invention.

### DETAILED DESCRIPTION OF THE PREFERRED EMBODIMENT

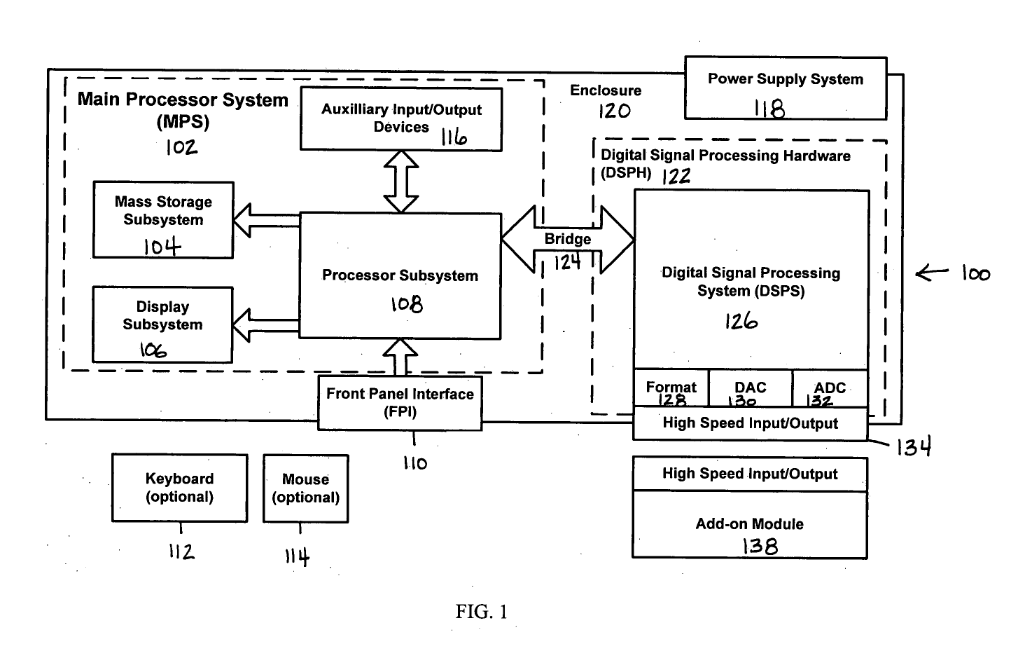

In FIG. 1 a block diagram of the preferred embodiment of the present invention 100 is shown. The present invention 100 contains a main processor system (MPS) 102 housed within an enclosure 120. Internal power is supplied to the main processor system (MPS) 102 from power supply system 118. The power supply 118 provides AC mains to DC system voltage conversion.

Main Processor System

The main processor system (MPS) 102 controls the overall system configuration. The main processor system (MPS) 102 contains the processor 108, software, display 106, mass storage 104, input devices and output devices which are used to configure and operate the present invention 100 as a whole. The preferred embodiment of the MPS 102 is a single board computer with on-board peripherals for video, audio, mass storage control, and networking, and other peripherals expected of a personal computer. The preferred embodiment of the present invention 100 will be compatible with off-the-shelf operating system (OS) software, thereby opening up a feature rich environment which provides methods of adding value to the invention through the use of printers, networking, extra storage options, and the like.

System Software

The system architecture of the present invention provides a flexible framework for implementing DSP systems. The framework describes the interaction of the system software residing in the MPS 102 and hardware components in the DSPH 122, and the methods for communication between these systems.

The system software has several responsibilities. It coordinates tasks throughout the entire invention 100 and manages the configuration of the DSPS 126. The system software also sources and sinks data for the DSPS 126 processes and provides the user interface, including graphical display of processed data. The task coordination and DSPS 126 configuration management are largely static processes which do not impose significant constraints on the required software system architecture. To meet the remaining needs of the software system, which are more performance critical, the architecture emphasizes efficient movement of data into and out of the DSPS 126 while allowing access to the data for display processing or storage.

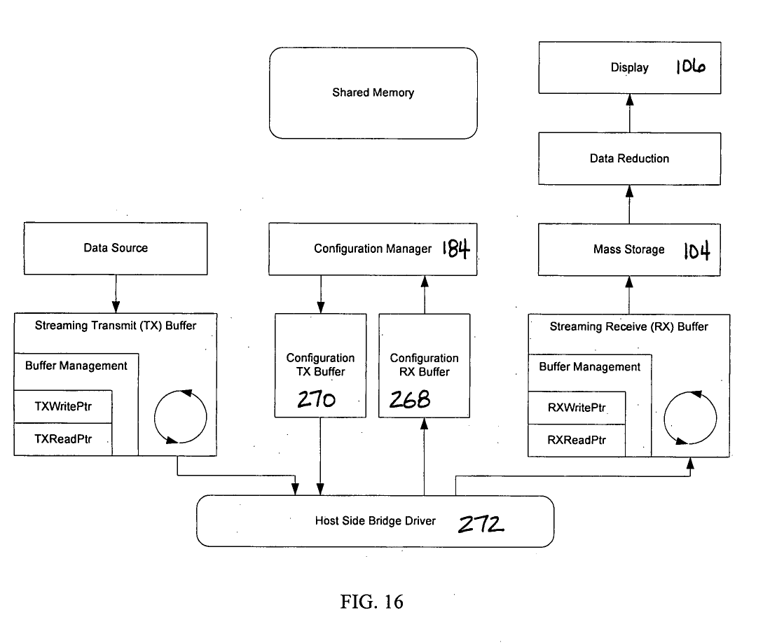

The system software is divided into independent processes. These processes communicate information to each other through a shared memory resource which is exposed to the individual processes through function calls. The shared memory resource can be used to enable and configure software processes as is needed by the current configuration of the system. A pictorial view of the system software structure is shown in FIG. 16. In this view, the critical data paths are shown with lines and arrows. Implied paths exist between the individual processes and the shared memory to allow inter-process communications.

The system software communicates with the DSPS 126 through the bridge 124. The software architecture allows for two different types of communications to occur across the bridge 124 in either direction. The first type of communications allows for continuous data streaming, supporting requirements for data sourcing, data sinking, and display of data processed in the DSPS 126. The second type of communications is a short transaction type of communication which allows short messages or raw accesses to pass between the system software and the DSPS 126. This second type of communications may include a protocol for data transfer, data protection, guaranteed delivery, etc.

The DSPS 126 resources appear to the system software as memory mapped locations across the bridge 124. The configuration manager 184 (See FIG. 16) maintains the list of memory mapped resources, and their respective addresses in the DSPS 126. This allows the memory map to be changed from DSPS 126 to DSPS implementation. The system software interface as seen by the DSPS 126 is established by the configuration manager 184 (See FIG. 16) at the time of DSPS 126 configuration. In this manner the optimal data transfer method can be used by the DSPS 126, as described by the CM 184 (See FIG. 16), promoting the ability to change the data transfer method to meet the specific needs of specific DSPS 126 implementations.

The system software coordinates the operation of the entire invention 100. The system software consists of several layers of software executing on the processor subsystem 108. The layers include software such as an operating system (OS), device drivers, database engine, and custom executable programs. The system software's two main functions are presenting the graphical user interface (GUI), and managing the configuration of the DSPH 122 with a configuration manager 184 (See FIG. 16), to implement the user desired DSPS 126.

Graphical User Interface

The first function of the system software is presenting the graphical user interface (GUI) within the display subsystem 106. The graphical user interface allows the user to interact intuitively with the system. Graphical models of possible system configurations will be stored in the configuration manager 184 (See FIG. 16) and presented to the user through the GUI. The user will be able to configure these models through parameters generated by the configuration manager 184 (See FIG. 16).

Configuration Manager

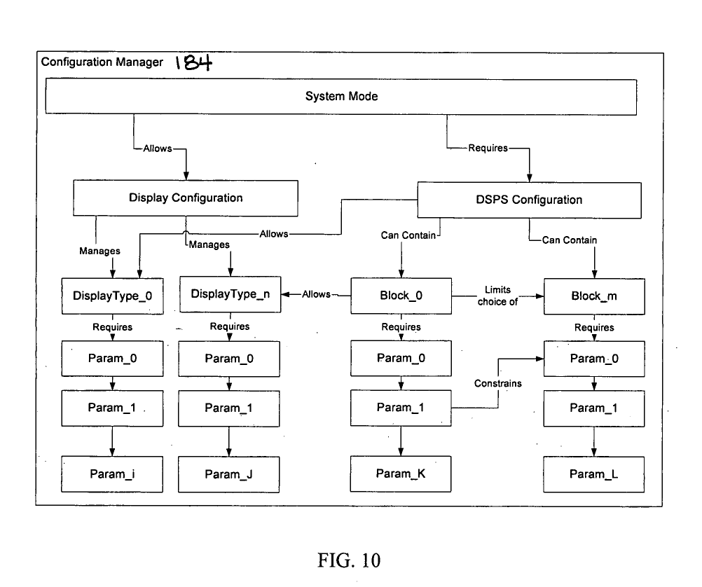

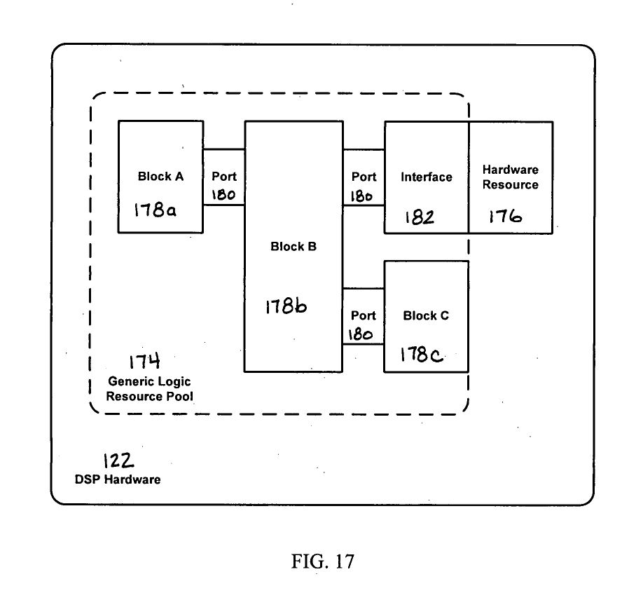

The configuration manager (CM) 184 (See FIG. 16) keeps track of the modes of operation which the system with the current DSPH 122 and software can support. The CM 184 (See FIG. 16) accomplishes this by creating models of the various modes available for the given resources. These models include lists of parameters that describe the configuration of the DSPH 122, and lists of dependencies that the model will require for a given configuration. The selection of any mode by the user will configure the DSPH 122 into one or more blocks 178a-c (See FIG. 17) which describe the basic functions needed to implement the mode. The CM 184 (See FIG. 16) tracks the capabilities of different modes, as well as the interdependencies of configuration choices based on DSPS 126 configuration unit blocks. A sample of interdependencies of system elements based on choice of mode and configuration for the configuration manager 184 (See FIG. 16) is provided in FIG. 10.

Configuration data obtained by the configuration manager 184 (See FIG. 16) may be stored using the configuration RX buffer 268 and recalled using the configuration TX buffer 270 as needed. The configuration data may include elaborate test setups, system state information, and system parameter information. Stored system parameters may include the state of the DSPS 126, the configuration of HSIO 134 ports, preferred graphical displays, or other things which are established by user preferences. Additionally, the configuration data may be associated with a unique identification string stored on the AOM 138. This unique identifier may be used to recall configuration information to restore system parameters. The system will be able to store, retrieve, name/rename, copy or delete configuration data from the system's MSS 104.

Processor Subsystem

Within the MPS 102 is a processor subsystem 108. The processor subsystem 108 receives user input from the input device(s), which consist of an optional mouse 114, optional keyboard 112, and a front panel interface (FPI) custom input device 110. Through the input devices, the user interacts with the system software to select and configure modes of operation. The input devices for the system consist of front panel interface (FPI) controls 110, an optional keyboard 112, and an optional mouse 114. The FPI controls 110 provide soft keys, a numeric key pad, a knob, and other utility keys in a fashion similar to existing test equipment. Soft keys are buttons located near the display device. The meaning of a soft key can change as needed. The current function of the soft key is described in an area on the display device that is associated with the soft key.

The processor subsystem 108 is also responsible for executing the code which oversees the configuration and operation of the present invention 100. The processor subsystem 108 as defined here includes processor support systems such as cache memory, main memory, clock generation, etc. The preferred embodiment of the present processor subsystem 108 is a PC compatible processor with numeric coprocessor. The processor subsystem 108 also interfaces to a display subsystem 106 which presents information to the user through a graphical user interface (GUI).

Display Subsystem

The display subsystem 106 is responsible for presenting the user with the graphical user interface supplied by the system software. The display subsystem 106 consists of a color display and a display adapter. The display is integrated in the system chassis, mounted at the front of the chassis for easy viewing by the user. The display adapter is preferably integrated on the MPS 102 main board, but can exist as a peripheral. The display may present additional outputs through the auxiliary input and output ports (AUXIO) ports 116 for support of external monitors. The auxiliary input and output (AUXIO) devices 116 consist of the communication interfaces which expose the MPS 102 to the outside world. These devices are grouped into a single broad category here, as they serve utility functions which provide added features for the overall system, but are not critical to the operation of the DSP capabilities of the system. The AUXIO devices 116 consist of common PC platform communication peripherals such as Ethernet, USB, RS-232, parallel (printer) port, and VGA video.

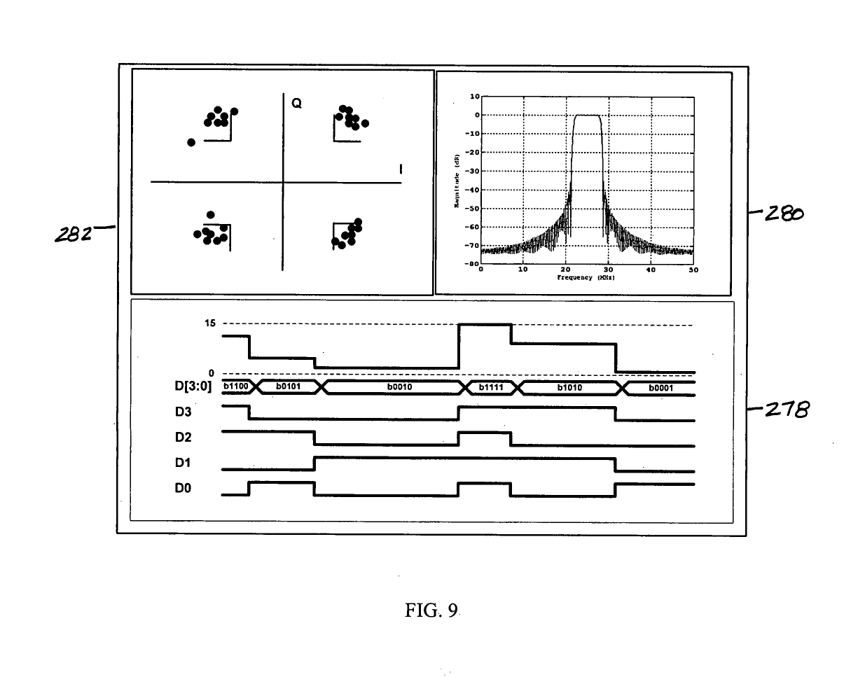

FIG. 9 is a block diagram of digital data obtained from the display subsystem 106 of the preferred embodiment of the present invention 100. A constellation diagram 282 is provided along with a graph of the output in spectrum analyzer mode 280 and output with a logic analyzer 278. The display of the present invention shows the frequency domain representative of the data, as well as specialized modes of display which may be enabled for certain types of input data.

Digital Signal Processing Hardware

The MPS 102 connects to the digital signal processing hardware (DSPH) 122 through a bridge 124. The bridge 124 provides a physical data path and control signals which interface the host side bridge (HSB) 272 (See FIG. 16) and client side bridge (CSB). All communications between the DSPS 126 and the MPS 102 pass through the bridge 124. The preferred embodiment for the bridge 124 is a PCI bus. The host-side bridge (HSB) 272 (See FIG. 16) consists of the electronics and software which transport data from the MPS 102 to the DSPS 126 through the bridge 124. The preferred embodiment of the HSB 272 (See FIG. 16) is a PCI controller and the associated driver software.

The DSPH 122 consists of generic logic resources (GLR) 174 (See FIG. 17) which can be configured to implement digital signal processing functions. In addition to the GLR 174 (See FIG. 17), the DSPH 122 also contains circuitry for support of DSP functions which collectively is referred to as the digital signal processing system (DSPS) 126. A DSPS 126 has specific features and capabilities which are controlled and configured by the configuration manager 184 (See FIG. 16). This circuitry includes memory (not shown) and optionally additional microprocessor(s) (not shown). Bridge circuitry (not shown) is also included to implement the client portion of the bridge 124. The DSPH 122 is modular, and can be replaced when requirements for DSP applications progress. The DSPH 122 is configured through software to implement a system within the DSPH 122 capable of performing some signal processing, communications, or analysis task.

Generic Logic Resources

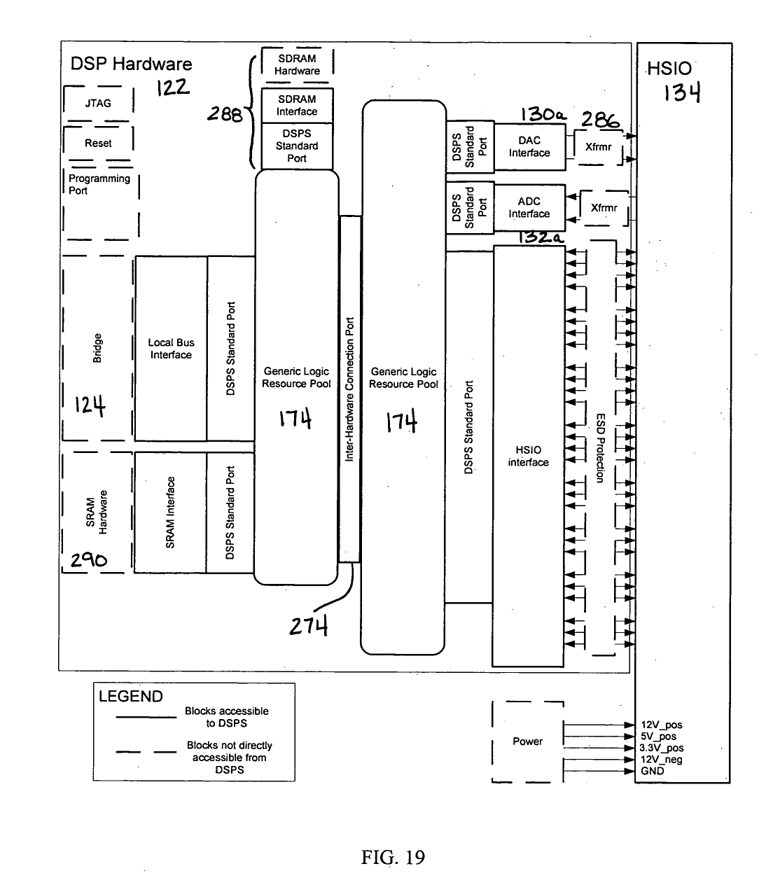

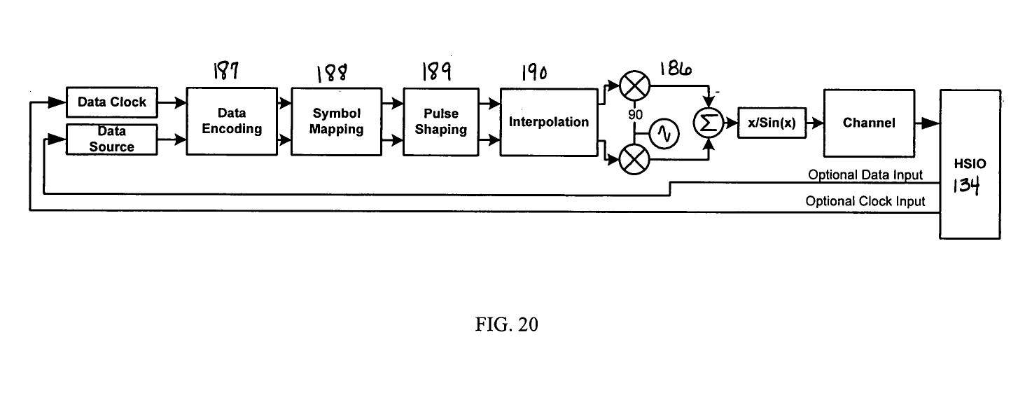

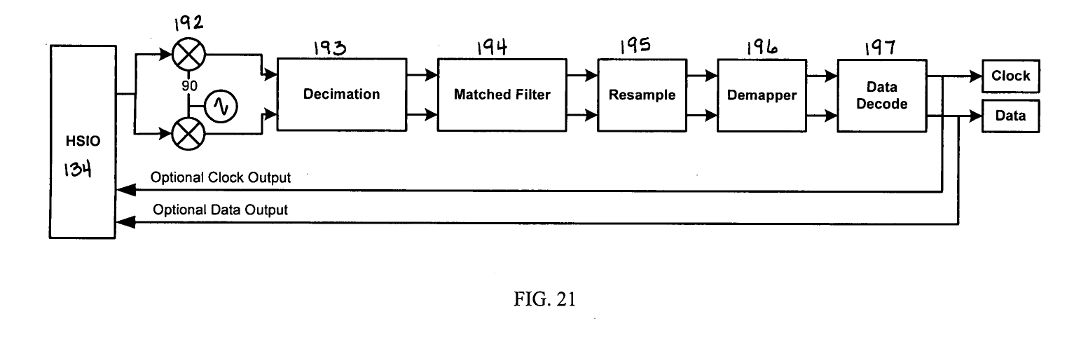

The generic logic resources (GLR) 174 (See FIG. 17) of the DSPH 122 consist of organized groups of programmable logic devices (PLDs) or application specific integrated circuits (ASICs). The preferred method for implementing the GLR 174 (See FIG. 17) is to use field programmable gate arrays (FPGAs) 290 (See FIG. 19). FPGAs 290 (See FIG. 19) typically are SRAM based devices which can contain large quantities of generic logic capable of operating at high data rates. FPGAs 290(See FIG. 19) are reprogrammable, allowing the system to be configured for operation in a particular mode such as a quadrature transmitter 186 (See FIG. 20), and then subsequently be reconfigured in another mode such as a quadrature receiver 192 (See FIG. 21) as needed. This capability allows the system to minimize the overall space requirements for the GLR 174 (See FIG. 17), as only the most expensive solution in terms of space, pin count, power consumption, etc. need to be accommodated in the system level design. It is not necessary to design all of the desired capability of the system to operate simultaneously thereby reducing the system requirements to the worst-case requirements of the most implementation expensive mode of operation.

High Speed Memory

A group of high speed memory (HSM) 288 (See FIG. 19) resources connect to the GLR 174 (See FIG. 17) as purpose specific hardware resources 176 (See FIG. 17). These resources 176 may be implemented in different memory technologies such as double data rate (DDR) or quad data rate (QDR) synchronous dynamic random access memory (SDRAM), static random access memory (SRAM), or other standard topologies. The preferred embodiment for large memory arrays in the DSPH 122 is a double data rate synchronous dynamic random access memory (DDR SDRAM) system 288 (See FIG. 19). The high speed memory (HSM) 288(See FIG. 19) connects to the GLR 174 (See FIG. 17) through an interface 182 (See FIG. 17) which is specific to the type of memory used in the HSM 288 (See FIG. 19). The GLR 174 (See FIG. 17) may have several HSM units available for use by a DSPS 126.

Digital Signal Processing System

The DSPS 126 uses DSPH 122 resources to implement DSP systems or components of DSP systems. The DSPS 126 internal structure consists of blocks A, B, and C178a-c (See FIG. 17) respectively, ports 180 (See FIG. 17), and interfaces 182 (See FIG. 17). Blocks 178a-c (See FIG. 17) represent fundamental functional processing units which operate on inputs to produce outputs. Ports 180 (See FIG. 17) represent standardized interconnection systems which constrain the format of signals between blocks 178a-c (See FIG. 17), and between blocks 178a-c (See FIG. 17) and interfaces 182 (See FIG. 17) to ensure connection compatibility. Interfaces 182 (See FIG. 17) are hardware specific blocks which translate the interface of hardware resources into a port. A conceptual example of a DSPS 126 system using blocks 178a-c (See FIG. 17), ports 180 (See FIG. 17), and an interface 182 (See FIG. 17) are shown in FIG. 17.

In this example, block B 178b (See FIG. 17) connects to block A 178a (See FIG. 17) and block C 178c (See FIG. 17) through ports 180 (See FIG. 17). Signal transfer between these blocks 178a-c (See FIG. 17) is governed by the type of ports through which the signals travel. Additionally block B 178b (See FIG. 17) can access a specific hardware resource 176 (See FIG. 17) through the port 180 (See FIG. 17) and interface 182 (See FIG. 17) connected to the resource 176 (See FIG. 17). A more practical construction of a DSPS 126 on DSPH 122 is shown in FIG. 19 for additional reference.

Blocks 178a-c (See FIG. 17) represent fundamental functional processing units. They serve to define the signal and control domains which are required to accomplish the process of the block. This method of packaging functional units allows the blocks to be reused within a design, or in other designs. Blocks 178a-c (See FIG. 17) consume GLR 174 (See FIG. 17) pool resources, so consequently a block cannot be larger than the GLR 174 (See FIG. 17) pool which contains the block. Typically blocks represent major system components or functions such as: microcontrollers, fast Fourier transforms (FFT), finite impulse response (FIR) filters, and the like. The definition of any particular block's function is defined as needed by the invention designers. In this system any block may be created so long as it consists of a logical grouping of functionality, with well defined purpose and ports.

Ports 180 (See FIG. 17) represent standardized interconnection systems which constrain the format of the input and output signals to ensure inter-block connection compatibility. Ports 180 (See FIG. 17) collect and define the signal and control connections into logical groupings. Ports 180 (See FIG. 17) also enforce a set of rules on the connections and signals contained within the port 180 (See FIG. 17). These rules allow for seamless interface to other blocks using compatible port types. This system enables data transfer between arbitrary blocks so long as the port types are compatible. Additionally, by using this system of ports to interface blocks to each other, blocks can be re-ordered within a DSPS 126 configuration and re-used across different DSPS 126 configurations.

All ports are described by port standards which detail the required signals and their operation at the port boundaries. Port standards include timing requirements, control signal definition, data signal definition, signal format, port size, port drive level requirements, and other pertinent information required to implement a standard set of inter-block interfaces. The DSPS 126 may use several differently defined ports to handle different types of signal interfaces. Inter-Hardware Connection Ports 274 may be used to extend the DSPS 126 across two or more hardware resources which contain GLR 174 (See FIG. 17) pools as shown in FIG. 19.

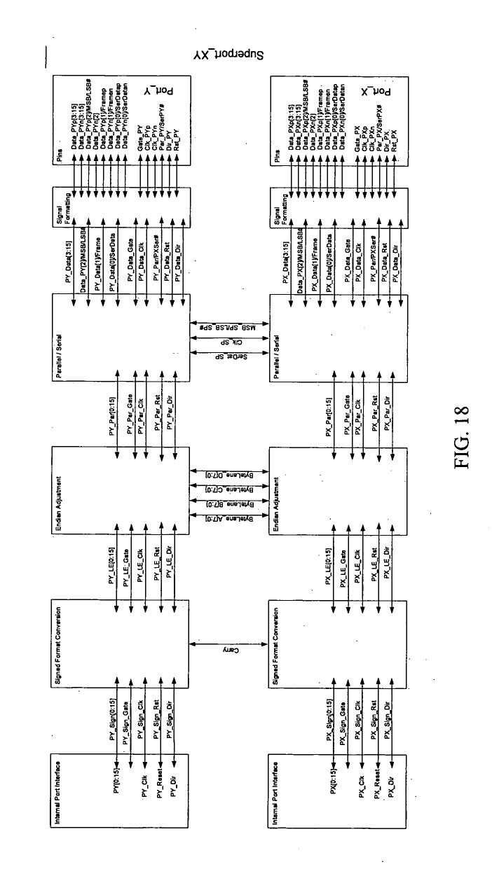

The DSPS 126 architecture requires hardware interfaces to convert the standardized ports to a hardware specific interface 182 (See FIG. 17). This allows the internal structure of blocks within the DSPS 126 which require specific DSPH 122 resources to remain unaware of the DSPH 122 structure. Interfaces 182 (See FIG. 17) are required for any hardware resource 176 (See FIG. 17) containing an interface 182 (See FIG. 17) which is not fully compatible with a standard port definition. An example of an interface between DSPS 126 and HSIO 134 is shown in FIG. 18. The interface 180 (See FIG. 17) allows parallel, serial, big-endian, little-endian, 16-bit data, 32-bit data, and sign conversions at the HSIO port 134 to operate with DSPS 126 blocks.

The DSPS 126 connects to the high speed input and output (HSIO) ports 134, and to a digital to analog converter (DAC) 130, and an analog to digital converter (ADC) 132. An analog to digital converter (ADC) 132 connects to the GLR 174 (See FIG. 17) through the ADC's digital interface 132a. The analog interface of the ADC 132 is transformer 286 coupled to the HSIO 134 port for interfacing to electronics on an AOM 138. The ADC 132 input circuitry does not attempt to limit the frequency of the ADC 132 input as is typically done with ADC analog ports to prevent aliasing. Filtering of the ADC 132 input is left to circuitry on the AOM 138. This allows the user to design analog systems which may utilize baseband sampling, or undersampling for direct IF processing. Baseband sampling is supported by the implementation of an anti-aliasing low-pass filter on the ADC 132 input. This filter must be implemented on the AOM 138. In baseband sampling mode the ADC 132 will directly digitize the data present at the ADC 132 input. This method provides a known analog interface for designers to use during the development of their designs.

A digital to analog converter (DAC) 130 connects to the GLR 174 (See FIG. 17) through the DAC 130 digital interface 130a. The analog interface of the DAC 130 is transformer 286 coupled to the HSIO port 134 for interfacing to electronics on an AOM 138. The DAC 130 output circuitry does not limit the frequency of the DAC 130. Filtering of the DAC 130 output is left to circuitry on the AOM 138. Baseband signal reconstruction is supported by the implementation of an anti-aliasing low-pass filter on the DAC 130 output. This filter must be implemented on the AOM 138. With baseband signal reconstruction the DAC 130 will directly reproduce the data present at the DAC 130 input. Bandpass signal reconstruction is supported by implementing a band select filter on the AOM 138 after the DAC 130 output. The DAC 130 internal analog circuitry is selected to support direct IF reproduction, allowing use of the DAC 130 beyond the first Nyquist zone.

A mass storage subsystem (MSS) 104 is provided. The mass storage subsystem (MSS) 104 consists of a hard disk drive (HDD) (not shown) and hard disk drive controller (not shown). The mass storage system (MSS) 104 contains the system software executable files(s), support files, user defined data files, database files, configuration information, and test results.

The high speed input and output (HSIO) 134 block is a set of high-density interconnects capable of transporting high data rate signals while maintaining signal integrity. These interconnections serve as the interface between the add-on module 138 and the rest of the system. Through this interface, high data rate digital signal representations are exchanged between the DSPS 126 and the add-on modules 138.

Add on Modules

Add-on modules (AOM) 138 may be connected to the DSPS 126, ADC 132, and DAC 130 through the HSIO 134 ports. The AOMs 134 contain circuitry which extends the capabilities of the digital signal processing system (DSPS) 126, and tailors the electrical interface of the invention to satisfy the user's requirements. AOMs 138 may contain header pins (not shown) to allow connection of wires and test leads for interfacing other designs to the invention 100. Other modules may contain digital signal processors, memory, and support chips, to allow the designer to develop and test algorithms with the aid of the invention in their native digital format. Additionally, an add on module 138 may contain programmable logic, which is intended to implement DSP algorithms. Other add on modules 138 may contain ADCs 132 or DACs 130 which may convert the signals at the HSIO port 134 to formats compatible with analog test equipment.

The add-on modules 138 are an open platform for extending the functionality of the system to meet the needs of particular users. Add-on modules 138 allow for simple interconnect with existing digital designs or for the extension of the DSPH 122 out of the invention chassis. The extended portion of the DSPH 122 is made available to developers allowing them to design and test algorithms even when the developer does not have custom hardware to implement their DSP functions. Several possible AOM 138 configurations are described below.

Probe Interface AOM

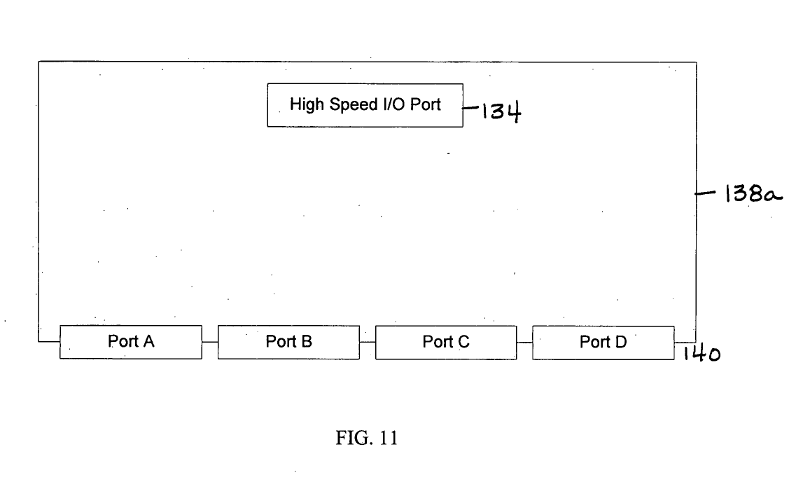

The most simplistic AOM 138 is a probe interface AOM 138a (See FIG. 11) which consists of a break-out system to convert the HSIO 134 interconnect to a series of header pins which can support ribbon cable, or individual wires with pin-probes for connection to integrated circuit pins. This AOM 138a (See FIG. 11) allows the invention to interface with low to medium speed logic existing on a user designed circuit board. This interconnection system is similar to interconnections common to logic analyzers. The probe interface AOM 138a (See FIG. 11) phase matches the traces between the HSIO port 134 and each of the breakout ports 140 (port A-port D)(See FIG. 11), to minimize skew between signals. This system allows the most general interface for users to connect the invention to their own systems. An example probe interface AOM 138a is shown in FIG. 11.

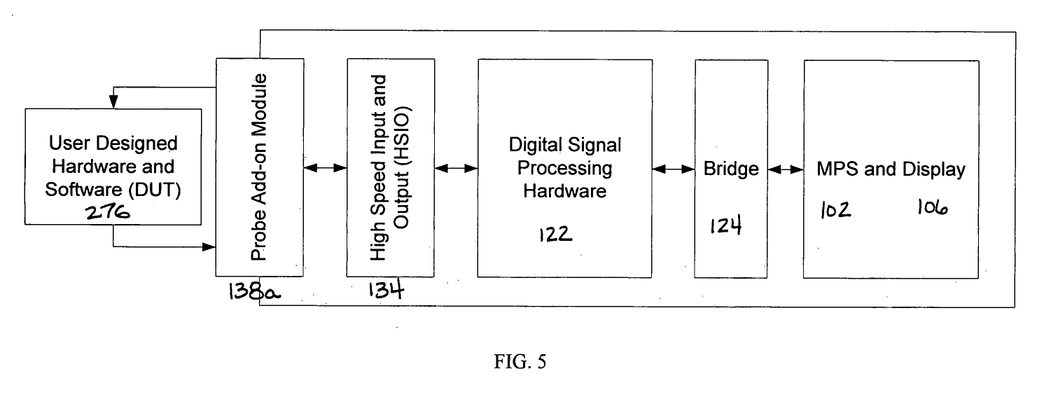

FIG. 5 shows the present invention 100 configured as inline development with user supplied hardware and software 276. A main processor system (MPS) 102 is provided having a display subsystem 106. The MPS 102 is connected to bridge 124 that links to DSPH 122. DSPH 122 provides HSIO 134. HSIO 134 is connected to probe add on module 138a.

Field Programmable Gate Array (FPGA) Development Platform AOM

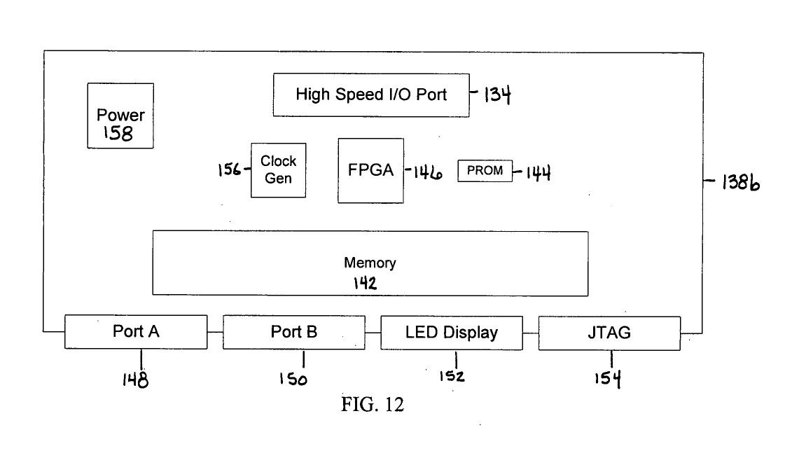

A field programmable gate array (FPGA) development platform AOM 138b (See FIG. 12) allows developers to implement DSP algorithms on an FPGA platform while leveraging the display and processing capabilities of the present invention. The ability to make an AOM with a user programmed FPGA, provides a novel platform for the creation and refinement of DSP algorithms on FPGA. Each FPGA platform AOM 138b (See FIG. 12) is able to target one FPGA model from a particular vendor. Multiple FPGA platform AOM(s) 138b (See FIG. 12) serve to address each of the major FPGA vendors, and the major vendor product lines. The AOM shown in FIG. 12 is a generic FPGA AOM 138b (See FIG. 12) development platform which can interface with the present invention. The major components of the FPGA platform AOM 138b (See FIG. 12) include the HSIO interface 134, the user programmable FPGA, a memory interface 142 (See FIG. 12), the FPGA 146 (See FIG. 12), a programmable read only memory (PROM) 144 (See FIG. 12) to program the FPGA at start-up time, and external ports which the FPGA can access directly.

The FPGA interfaces directly to the HSIO port 134 to interact directly with the present invention. Additionally the FPGA interfaces directly to generic header interfaces at port A 148 (See FIG. 12) and port B 150 (See FIG. 12) to allow connection of the user FPGA to external circuitry or equipment. This configuration allows the user to program the FPGA to process external data from port A 148 (See FIG. 12) and port B 150(See FIG. 12), and route results to the DSPS 126 for processing and display. This allows the user to develop portions of a DSP system in the absence of a complete signal processing chain. Additionally this configuration provides feedback through the display capabilities 152 (See FIG. 12) of the invention, allowing the developer to refine their design. The DSPS 126 can be configured to source data to the FPGA AOM 138b(See FIG. 12), receive data from the FPGA AOM 138b (See FIG. 12), or provide loop back routing of data from the DSPS 126 through the FPGA platform AOM 138b (See FIG. 12) and then back to the DSPS 126.

The joint test action group (JTAG) 154 (See FIG. 12) interfaces of the FPGA 146 and PROM 144 (See FIG. 12) are exposed through the AOM JTAG 154 (See FIG. 12) port. This allows the user to program and troubleshoot the FPGA algorithms within the capabilities of the JTAG interface. This approach allows feature rich FPGA vendor programs to interface with the FPGA 146 (See FIG. 12) through the standards based JTAG port 154, extending the AOM FPGA 138b (See FIG. 12) into most third party FPGA software development systems. These interactions with the vendor software allow the user of the AOM FPGA 138b (See FIG. 12) platform to program code, and then download it to the AOM FPGA 138b (See FIG. 12) through an interface with which the user is already familiar. This leverages the vendor supplied and updated FPGA development software with no additional costs to the invention.

A clock generator circuit 156 (See FIG. 12) is provided on the AOM 138b (See FIG. 12) to provide a flexible clock system capable of matching symbol rates needed by the user for their designs. A simple LED display 152 (See FIG. 12) is included on the AOM 138b (See FIG. 12) to provide basic status information such as power, heartbeat, and error detected. An on module power supply 158 (See FIG. 12) provides core voltages and interface voltages outside those available from the system power supply. Synchronous dynamic random access memory (SDRAM) 142 (See FIG. 12) is located on the AOM to support user designs which require large amounts of high-speed memory.

DSP Processor Development Platform AOM

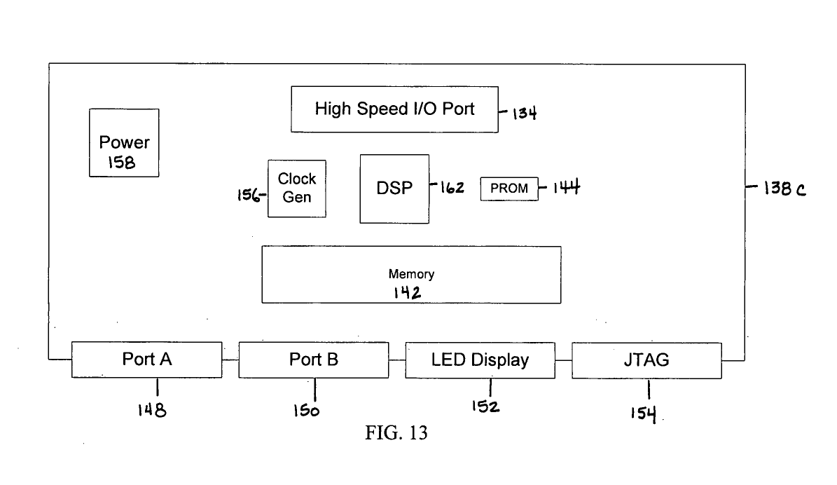

The DSP processor AOM 138c (See FIG. 13) development platform is very similar to the FPGA development platform AOM 138b (See FIG. 12), except instead of using the FPGA 146 (See FIG. 12) to process digital signals a DSP microprocessor 162 (See FIG. 13) implements the user's algorithms. The DSP processor AOM 138c (See FIG. 13) is specific to a particular manufacturer and model of DSP microprocessor, in the same manner the FPGA AOM 138b (See FIG. 12) is particular. Several DSP processor AOM 138c (See FIG. 13) development platforms are needed to serve the common signal processors available in the marketplace. An example layout of a DSP processor AOM 138c is shown in FIG. 13. The same support hardware is available in the processor platform and the FPGA platform.

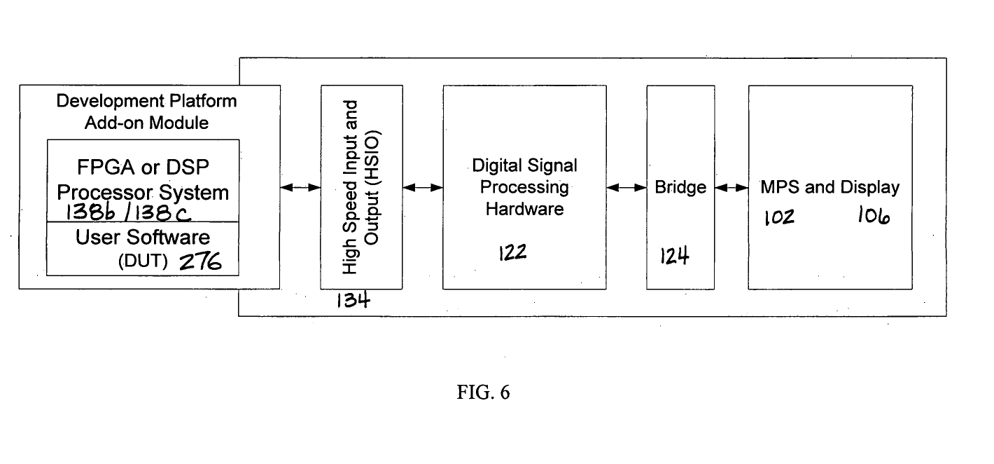

FIG. 6 shows the present invention 100 configured as inline development with user supplied software 276. A main processor system (MPS) 102 is provided having a display subsystem 106. The MPS 102 is connected to bridge 124 that links to DSPH 122. DSPH 122 provides HSIO 134. HSIO 134 is connected to FPGA processor development AOM 138b (See FIG. 12) or DSP processor development AOM 138c (See FIG. 13).

Radio Frequency Interface AOM

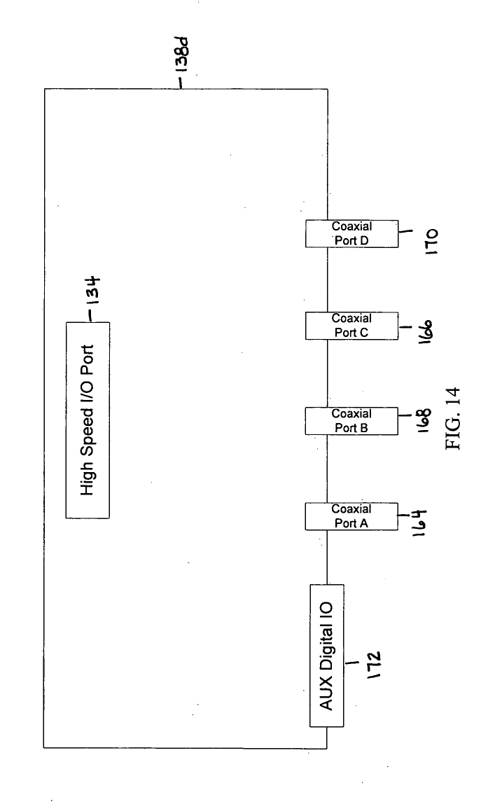

The radio frequency (RF) interface AOM 138d (See FIG. 14) provides analog signal processing for the ADC 132 and DAC 130 located on the DSPS 126. The RF AOM 138d (See FIG. 14) additionally provides filtering, gain control, frequency conversion, and convenient output ports compatible with other analog test equipment. The AOM layout is similar to the AOM shown in FIG. 13. The AOM accepts RF input at port A 164 (See FIG. 14), and produces RF output at port C 166 (See FIG. 14), within a specified power level and frequency range as determined by the specific analog interface AOM. Port B 168 (See FIG. 14) can be configured to produce either transmit (TX) or receive (RX) through a switched interface to support burst transceiver operation. The analog interface AOM 138d (See FIG. 14) also allows a reference to connect to port D 170 (See FIG. 14), allowing the AOM synthesis circuitry to lock to an external frequency reference. This AOM 138d (See FIG. 14) allows users to interface to RF test equipment, transmitters, and receivers. This AOM 138d (See FIG. 14) can form a complete digital transceiver system when combined with a suitably configured DSPS 126. Auxiliary input and output ports 172 are also provided.

Electronics Development Platform AOM

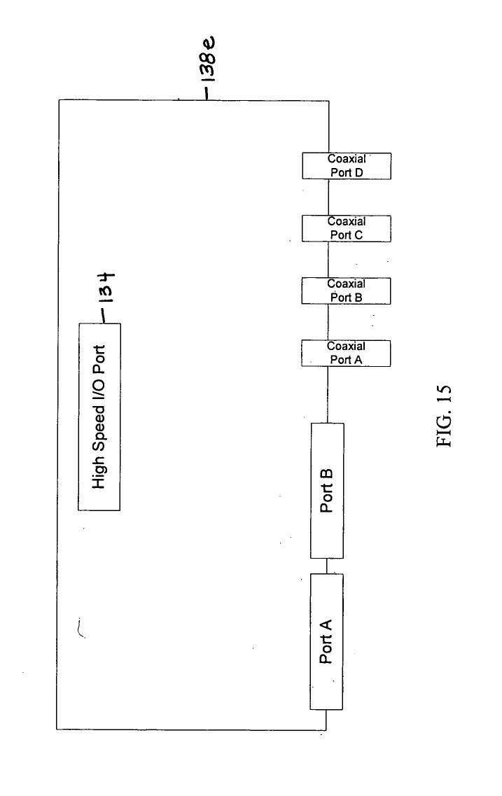

An electronics development platform (EDP) AOM 138e (See FIG. 15) is an open, fully-disclosed, AOM format for general use by developers. It allows developers to build their own custom electronic assemblies for use with the system. This allows developers to leverage the capabilities of the system to speed development efforts. This approach also allows developers to systematically evaluate designs with the AOM which they intend to deploy. The EDP AOM 138e (See FIG. 15) allows hardware and software development efforts to exist in co-development and converge at the data converters. This unique ability is granted to the user because of the flexibility of the DSPH 122 and the open platform EDP AOM 138e (See FIG. 15). For example, the needs of the hardware designer are met by the system's ability to source a digital signal representative of the system under development by the software engineer. With this signal, the hardware designer can create circuitry on the EDP AOM 138e (See FIG. 15) to evaluate different data converters and analog circuitry to assess how the circuitry affects the simulated signal sourced from the system. At the same time, the software designer can utilize a separate system to evaluate the software algorithms which will eventually combine and produce the signal which the hardware engineer is already developing circuitry to process.

The DSPH 122 is configured by the MPS 102 to perform any signal processing task within the capabilities of the DSPH 122. Example configurations of the DSPH 122 may include a quadrature receiver, quadrature transmitter, spectrum analyzer, oscilloscope, logic analyzer, pattern generator, waveform generator, signal source, channel impairment generator, or any other type of signal process which can be represented as a digital signal. Each configuration implemented in the DSPS 126 may have an associated display which represents information related to the configuration in a human readable form. The DSPH 122 can be configured in many ways to construct different DSP systems and blocks. Example configurations of several DSP operations as implemented in the DSPH 122 are described later. This list is intended for illustrative purposes, and should not be considered an exhaustive list of the systems the present invention could implement.

Example Modes of Operation for the Preferred Embodiment of the Present Invention

Examples showing possible configurations of the system are useful for understanding the capability of the overall invention. The following examples are not exhaustive of the configurations which could be implemented with the invention, but illustrate some of the modes of operation expected to be most popular.

Quadrature Transmitter

An example configuration for the present invention is to implement a quadrature transmitter 186 in the DSPH 122. In this mode, the hardware is configured as shown in FIG. 20. The generic logic resources 174 (See FIG. 17) in the DSPH 122 are used to create filters, mixers, numerically controlled oscillators (NCO)s, summers, and the like to produce a quadrature transmitter 186 capable of implementing the function x(t)=i(t)*cos(jwt)−q(t)*sin(jwt). Where x(t) is a real valued signal with a carrier frequency of wt, i(t) is the in-phase message signal, and q(t) is the quadrature-phase message signal. The input to the quadrature transmitter 186 could be provided by either the user through the HSIO 134 or from the MPS 102 which may store message data to transmit in the mass storage subsystem (MSS) 104.

The user configures the quadrature transmitter 186 through the user interface which is comprised of the system display, input devices, and software executing on the system processor. Through the user interface, the user parameterizes the quadrature modulator to fit the particular needs of the user's project. Parameterization is accomplished by displaying a graphical representation of the quadrature transmitter architecture on the system display and allowing the user to interact with the architecture by presenting dialog windows to configure the behavior of the blocks in response to the user selecting blocks with an input device. In this manner, the user will be given very broad control over the behavior of the quadrature transmitter 186. In the case of this example, the user may configure parameters for the data to be determined at steps 187-190 including, but not be limited to the source for transmit data origin, source for symbol rate clock, frequency of symbol rate clock, type of transmission (burst or continuous), data protection (error correction or detection, interleaving, differential encoding, etc.), symbol size (constellation complexity), symbol value to constellation mapping, pulse shaping filter length, pulse shaping filter output rate, pulse shaping filter shape type (raised cosine, raised root cosine, Gaussian, etc.), pulse shaping filter excess bandwidth, pulse shaping filter (arbitrary coefficients), interpolation filter rate, interpolation filter length, carrier generator frequency, carrier generator phase dithering, modulator spectral inversion, multi-source combining (choose other sources), output pin(s), and output clock(s).

After configuring the system as a quadrature transmitter 186, and providing the operational parameters through the user interface, the user will be able to produce a digital representation of a quadrature modulated signal at the HSIO 134. This data may be fed back into the present invention for further analysis, or connected through an add-on module 138 to other equipment. Other equipment may include a digital receiver under development, where the signal is fed to the receiver by bypassing the analog to digital converter on the receiver. Other options exist for connecting the output of the quadrature transmitter 186 to other test equipment or system components through the use of an add-on module 138 with the appropriate circuitry.

Quadrature Receiver

Another example configuration for the invention is to implement a quadrature receiver 192 in the DSPH 122. In this mode, the hardware is configured as shown in FIG. 21. The generic logic resources 174 (See FIG. 17) in the DSPH 122 are used to create filters, mixers, NCOs, summers, and the like to produce a quadrature receiver 192 capable of converting a real-valued quadrature modulated signal into its in phase and quadrature phase components. The receiver output is the data message contained in the real-valued modulated signal, and display of key receiver parameters or signal representations at critical receiver locations. The user configures the quadrature receiver 192 through the user interface as previously described. In this manner, the user is given very broad control over the behavior of the quadrature receiver 192. In the case of this receiver 192, the user may configure parameters such as those found in steps 193-197 including, but not be limited to down-conversion frequency, decimation filter output rate, matched filter length, matched filter output rate, matched filter shape type (raised cosine, raised root cosine, Gaussian, etc.), matched filter excess bandwidth, matched filter (arbitrary coefficients), matched filter adaptive characteristics, symbol de-mapping, data decode (error correction or detection, interleaving, differential encoding, etc.), output pin(s), output clock(s) and display mode(s).

After configuring the system as a quadrature receiver 192, and providing the operational parameters through the user interface, the user will be able to receive a digital representation of a quadrature modulated signal from the HSIO 134, and convert it to data and statistics relating to the received signal. The input to the quadrature receiver 192 is provided through the HSIO 134. The output of the receiver 192 is then presented to the HSIO 134 or to the MPS 102 for display or long term storage in the MSS 104. Further analysis of the received signal may be performed on the outputs of any block in the receiver chain. In this way, additional information may be presented to the user such as bit error rate (BER), constellation representations, eye-diagrams, symbol rate, carrier drift, and the like.

Quadrature Transceiver

The quadrature transceiver (not shown) is an extension of the quadrature transmitter 186 and quadrature receiver 192, into a single transceiver.

Channel Simulator

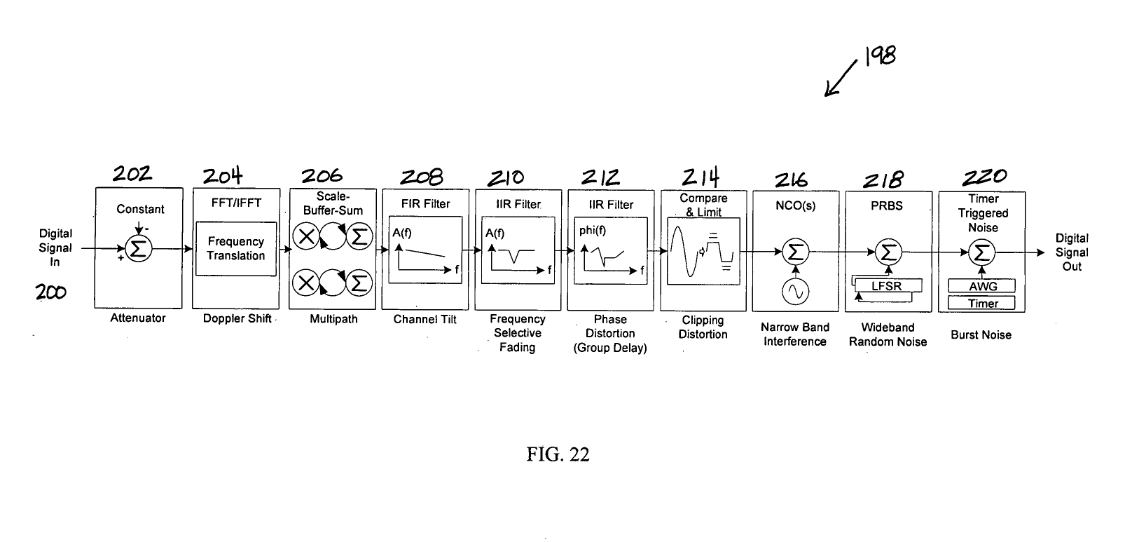

The present invention allows for a unique channel simulator 198 (See FIG. 22) which can be applied to communication systems, or omitted for other digital signal processing system where a channel simulator is not needed or has no meaning. The channel simulator 198 (See FIG. 22) can be interposed between a transmitter and a receiver to apply impairments common in transmission systems to a signal for the purpose of exercising digital communications designs in a real world context. The channel simulator 198 (See FIG. 22) is configured through a graphical user interface implemented in the MPS 102. The channel simulator 198 (See FIG. 22) consists of a cascade of operations which work together to produce a realistic simulation of real-world impairments. These blocks must operate on signals at data rates equal or greater than the rate of the signals passing through the channel simulator 198 (See FIG. 22). This requires the algorithms implemented in the channel simulator 198 (See FIG. 22) to operate efficiently with respect to speed if processing of high bandwidth signals is to be accomplished. The algorithms described here are presented for implementation in the GLR 174 (See FIG. 17), but any suitable digital processing hardware may be used to implement these operations, so long as the bandwidth requirements of the signals passing through the channel simulator 198 (See FIG. 22) are maintained.

The channel simulator 198 (See FIG. 22) blocks are provided in FIG. 22 and provide the following impairments for the input digital signal at step 200: channel attenuation with an attenuator at step 202, doppler shift at step 204, multipath interference at step 206, frequency dependent attenuation (coaxial cable “channel tilt”) at step 208, frequency selective fading at step 210, phase distortion (group delay) at step 212, clipping distortion at step 214, narrowband interference or jamming at step 216, wideband random noise at step 218, and burst noise and impulse noise at 220.

The present invention 100 enables a unique opportunity to implement a comprehensive communications channel simulator 198 (See FIG. 22) in a purely digital form. This novel approach to full channel simulation enables co-development of analog and digital communications hardware, as well as DSP algorithms. With the digital channel simulator 198 (See FIG. 22), portions of a digital receiver can be developed before the analog electronics for the receiver exist. This represents a novel approach to digital radio design because it allows the developer to design and refine the digital hardware and software to combat channel impairments during the entire design cycle instead of only after digital and analog integration which has been necessitated in the past.

The all-digital simulation is made possible by the invention's ability to interface with digital signals directly. The need for data converters in prior art simulators severely restricts the dynamic range of the simulation, as well as the bandwidth, and accuracy. With the present invention, large bit groupings can be used to represent signals and impairments. In the prior art, this was not the case, as the simulations were limited to the dynamic range of the converter at both the input and the output of the simulator, typically 10-14 bits. In addition to dynamic range limitations, prior art simulators suffered from non-ideal converter artifacts such as non-monotonic transfer functions, missing codes, imperfect linearity, glitch, and accuracies which often limited the effective number of bits available in the converter to a value less than the actual number of bits. In addition to these distortion and noise products, there remain non-trivial issues in prior art system to successfully implement the analog circuitry, at the converter analog port, to obtain optimal performance. These design issues are difficult enough that they often require a very experienced designer to overcome. The present invention avoids these impairments and pitfalls by eliminating the need for a converter altogether. To illustrate the difference between a converter limited simulator and the present invention, we compare two fictitious but reasonable simulator systems at the “signal in” port for each simulator. In the prior art system, an ideal 12-bit converter is used, while the present invention employs a 32-bit input port. The 12-bit converter is a common precision for use at the data rates encountered in communications systems. A well known formula relates the dynamic range of a converter when a full scale sinusoid is present at its port. This formula calculates the dynamic range limitation of the converter due to quantization noise when the number of bits available in the converter is known.

The formula is as follows:
SNR=6.02n+1.72 dB
Where:
n is the number of bits
SNR is the dynamic range when the input signal is full scale and sinusoidal

We calculate the SNR for the ideal 12-bit converter to be 74 dB, which means the converter and therefore the simulator cannot represent a signal with a dynamic range exceeding 74 dB. To contrast the idealized prior art converter against the present invention, we calculate the same SNR for a 32-bit system and arrive at a dynamic range of 194.4 dB for a difference of 120.4 dB. To further show the advantages of the present invention over the prior art, we realize that the converter used in the prior art would not be ideal as we assumed for ease of calculation, and the difference in performance between the systems would be even greater than 120.4 dB. Often the effective number of bits available with a 12-bit converter operating at sample rates common in communications systems approaches 10-11 bits. By using a 32-bit port, the present invention has enough dynamic range to simulate effects such as path loss and thermal noise directly. This type of simulation was not possible with the prior art.

Channel Attenuation Simulator

Channel attenuation is accomplished through a subtraction operation with an attenuator which subtracts a constant from the input signal at step 202 (See FIG. 22). Channel attenuation occurs due to signal spread in a free-space communications channel or through power dissipation. Attenuation can be used to simulate separation distance, and verify link-budget calculations.

Doppler Shift Simulator

Doppler shift at step 204 (See FIG. 22) is a phenomenon that produces an apparent change in carrier frequency at a receiver due to motion of the transmitter or receiver involved in the transmission. The carrier frequency will appear to increase if the transmitter or receiver is in motion towards the other, and conversely decrease if they are in motion away from each other. The channel simulator 198 (See FIG. 22) implements Doppler shift at step 204 (See FIG. 22) for a limited set of input signals. The simulator 198 (See FIG. 22) operates on the input signal with a fast fourier transformer (FFT), to make a frequency domain representation of the input signal. Frequency translation is accomplished by shifting the contents of the FFT bins according to the desired Doppler simulation settings. The shift includes two aspects, shift direction and shift magnitude. The magnitude is proportional to the desired simulated Doppler frequency, and the direction is determined by the sense of the change as seen by the receiver. A higher frequency shift shifts the FFT bins towards the higher frequency bound, and a lower frequency shift shifts the FFT bins in the opposite direction. The resulting Doppler shifted signal is then reproduced by an inverse FFT operation to recreate a time domain signal.

An alternative approach to Doppler shift simulation is available outside the channel simulator 198 (See FIG. 22). Doppler shift may also be simulated by a transmitter implemented in the invention by adjusting the NCO settings on the final up-converter process to account for Doppler shift at the receiver. This approach has no additional implementation costs associated with its use, but it requires the user to configure the invention as a transmitter.

Multipath Interference Simulator

Multipath interference at step 206 (See FIG. 22) is a phenomenon resulting from radio frequency (RF) reflections in the broadcast environment. Multipath interference at step 206 (See FIG. 22) is caused by the accumulation of n time-delayed and attenuated signals arriving at the same time as the original transmitted signal at the point of reception. The delayed signals are caused by reflections off man-made and natural objects including buildings, bridges, mountains and other objects which are large with respect to the wavelength of the transmitted signal. In general a receiver system must be able to distinguish from the true signal and the reflected signals creating the multipath interference. For this reason, the multipath simulator at step 206 (See FIG. 22) is needed to exercise digital signal receiver implementations against this common phenomenon.

The channel simulator 198 (See FIG. 22) allows for a user selectable number of multipath signals each having a user-defined delay time and selectable attenuation level. The multipath signals are generated from and added to the original signal input through a three stage process. The first process includes a scaling operation which is implemented by a multiplication of the signal against a scalar value. The second process involves producing n circular buffers in memory, and placing the n scaled signals in the buffers to affect delays on the signals. The third process involves extracting data from the n buffers and summing the data with the original non-delayed transmitted signal.

Channel Tilt Simulator (CTS)

Channel tilt at step 208 (See FIG. 22) is a frequency dependant attenuation which is a common phenomenon in cable based transmission systems. Cable structures typically have a gentle low-pass response, caused by the dielectric loss properties of the coaxial cables used to carry the signals. The mechanisms of this loss and the general magnitude of the loss with respect to frequency are well known to cable system engineers. The channel simulator 198 (See FIG. 22) implements this impairment by applying a finite impulse response (FIR) filter at step 208 (See FIG. 22) to the input of the channel tilt simulator (CTS) 208 (See FIG. 22). The FIR filter at step 208 (See FIG. 22) produces linear-in-dB attenuation with respect to frequency, allowing the cable system engineers to simulate the effects of signal transmission in long cables. The FIR filter at step 208 (See FIG. 22) can be implemented in a number of well known forms, which will be known to those skilled in the art.

Frequency Selective Fading Simulator

Frequency selective fading simulation at step 210 (See FIG. 22) is provided by an Infinite Impulse Response (IIR) filter at step 210 (See FIG. 22), configured as a notch filter. Filter attenuation, center frequency, and notch width are adjustable by modification of the filter taps. Frequency selective fading at step 210 (See FIG. 22) is caused by multiple phenomenon in real life. Typically frequency selective fading is the result of multipath interference which consists of two or more signals with unequal transmission times and amplitudes, but the generation of the effect is not limited to multipath interference. Other physical phenomenon such as periodic deformations in cable systems can cause a notch frequency response. The present invention allows the designer to test the performance of a receiver in the presence of a fade or notch. This allows the designer the ability to design algorithms to correct for the impairment. The IIR filter at step 210 (See FIG. 22) can be implemented in a number of well known forms, which will be known to those skilled in the art.

Phase Distortion Simulator

Phase distortion, or group delay, at step 212 (See FIG. 22) is simulated with an all-pass IIR filter at step 212 (See FIG. 22). This IIR filter produces a constant amplitude gain, but a configurable phase delay. This IIR filter simulates channel impairments which typically result from the introduction of analog components in the signal path. This allows the designer to test a receiver against a realistic channel that produces frequency dependant propagation velocities. This feature may also be used to implement phase correction for analog front-ends, as a means to enhance the overall performance of a transmission system. The IIR filter can be implemented in a number of well known forms, which will be known to those skilled in the art.

Clipping Distortion Simulator (CDS)

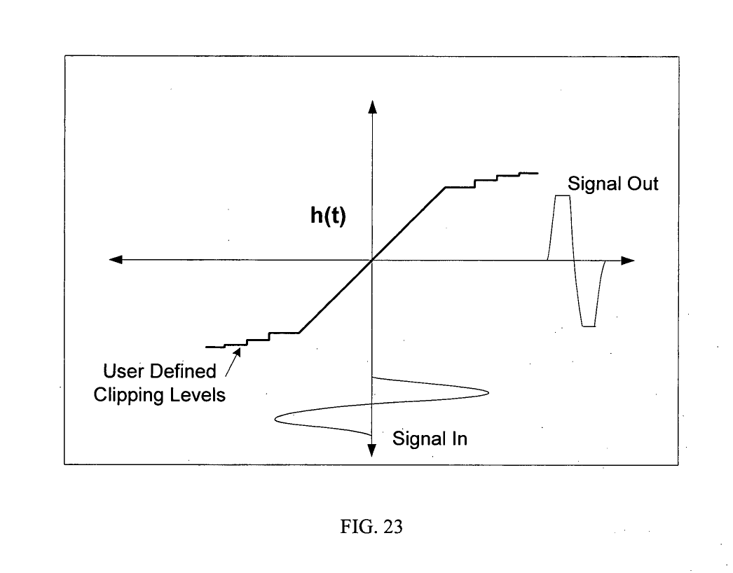

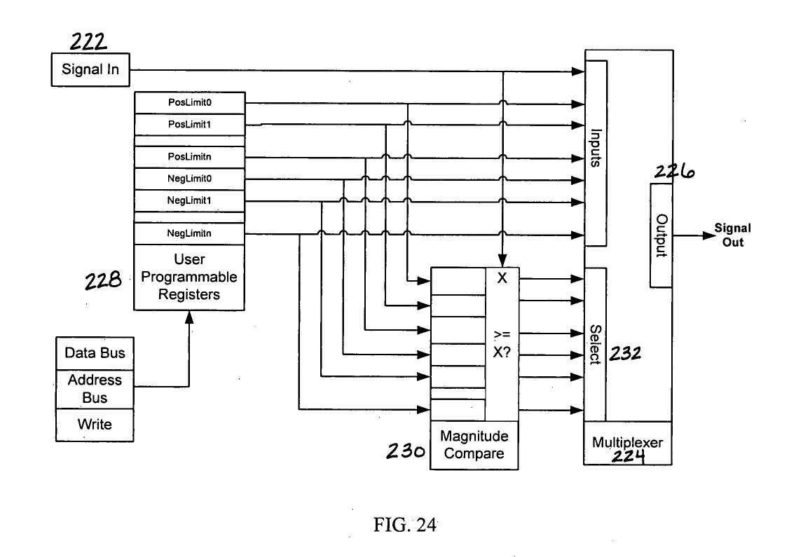

Clipping distortion at step 214 (See FIG. 22) is the result of a signal exceeding the finite dynamic range of the system generating, transmitting, or receiving the signal. Severe clipping is an indicator of device failure in the system, but light clipping may be encouraged to trade signal to noise ratio of a high crest factor signal against occasional clipping. This impairment allows the designer to make such a compromise, and understand the effects on system performance. Clipping distortion at step 214 (See FIG. 22) is simulated through a series of graduated hard limit functions which may be spaced in amplitude by the user arbitrarily within the range of the input signal. Symmetry of the limits about a mean value is not required. To simulate a typical channel utilizing solid state devices, the limit values may be spaced exponentially producing an approximation of a soft limit. This allows the user to define hard and soft clipping events which can be implemented in the generic logic resources. FIG. 23 shows an example transfer function of the clipping stage at step 214 (See FIG. 22) where the user has provided symmetric limit levels, spaced exponentially to simulate soft clipping. Implementation of the clipping distortion function at step 214 (See FIG. 22) in a GLR 174 (See FIG. 17) is shown pictorially in FIG. 24.

A signal in the channel enters the clipping distortion simulator at step 214 (See FIG. 22) through the “signal in” port at step 222 (See FIG. 24). The signal is sent to a multiplexer 224 (See FIG. 24) that passes either the signal, or user defined levels (limits) to the multiplexer output 226 (See FIG. 24). The user defined levels are stored in user programmable registers at 228 (See FIG. 24) which can be manipulated through the user interface. The user defined levels are used for two purposes. First, when selected, the user defined level will be directed to the output of the multiplexer 224 (See FIG. 24). This operation produces the clipping distortion at step 214 (See FIG. 22). Second, the user defined levels are compared against the value of the “signal in” data at step 222 (See FIG. 24) with a magnitude comparator 230 (See FIG. 24) to generate a set of selection signals at 232 (See FIG. 24) for the multiplexer 224 (See FIG. 24). These selection signals 232 (See FIG. 24) determine which limit is presented at the output of the multiplexer 224 (See FIG. 24) in response to a signal which has sufficient amplitude to produce clipping. When a signal does not have sufficient amplitude to produce clipping, the signal is passed through the multiplexer 224 (See FIG. 24) without modification. The preferred embodiment of the clipping distortion simulator of 214 is shown in FIG. 24. This embodiment can be efficiently implemented in the GLR 174 (See FIG. 17).

Narrowband Interference Simulator

Narrow band interference, or jamming, at step 216 (See FIG. 22) is simulated by implementing one or more numerically controlled oscillators (NCO) at step 216 (See FIG. 22), and adding the output of the NCOs to the channel. This process produces narrowband (sinusoidal) interferes, which can be positioned to interfere with a transmission existing in the channel. The amplitude and frequency of the interfering signals can be set by the user. This allows the user to simulate in-band interference, band edge interference, or out of band interference. The NCO can be implemented through a number of direct digital synthesis (DDS) techniques. Methods for implementing the NCOs will be well known to those skilled in the art.

Wide Bandwidth Random Noise Simulator

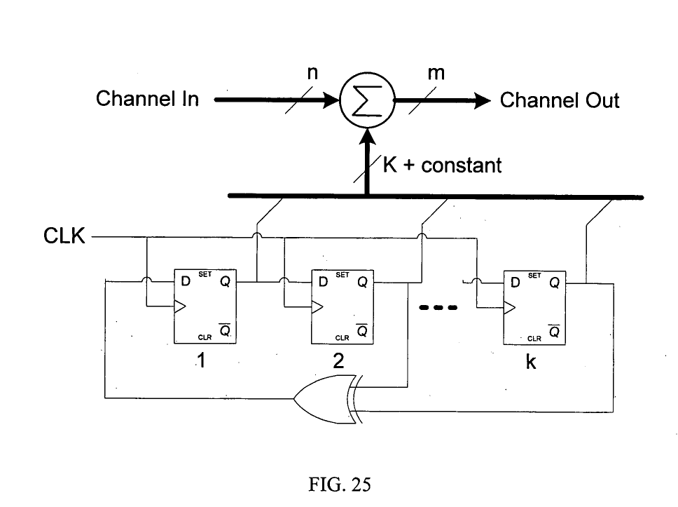

Wide bandwidth random noise at step 218 (See FIG. 22) is common in communications systems. Random noise is usually attributed to thermal noise generators which exist in all circuitry operating with resistance or with a temperature greater than 0K. The wideband noise is introduced into the channel by addition of a pseudo random bit sequence (PRBS) to the channel contents. The amplitude of the noise is controlled by controlling the number of bits and the magnitude of the most significant bit which is involved in the noise addition. For a channel represented by n-bits and a noise generator represented by k bits of output (n>=k), the magnitude of the noise addition can be controlled by offsetting the noise from zero by a constant. Generation of PRBS is well known in the art, and an example of a wideband noise generator based on a linear feedback shift register (LFSR) is shown in FIG. 25.

Burst Noise Simulator

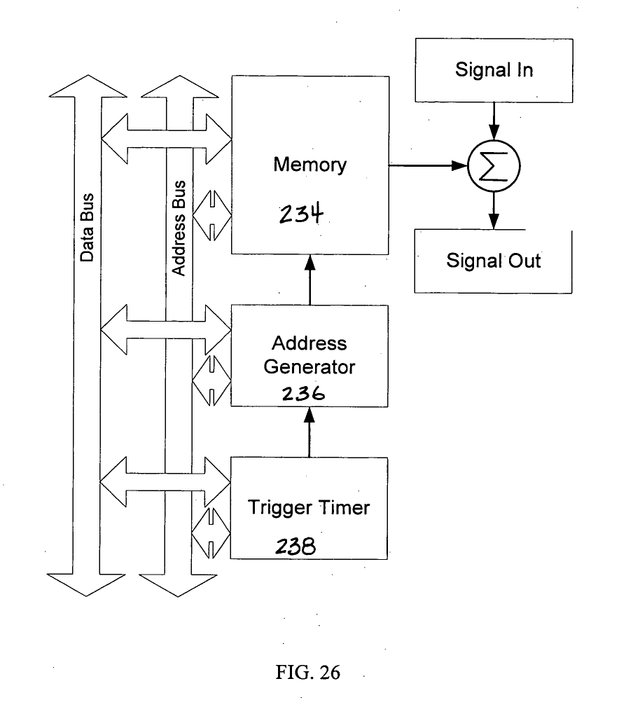

Burst noise, or impulse noise, at step 220 (See FIG. 22) is a temporary impairment that occurs on a communication channel. Burst noise is usually large in amplitude and may last several microseconds to several seconds depending on the source of the noise. This type of impairment is usually caused by an electrical disturbance such as lightening, motor noise, or electrical switch operations. The occurrence of such noise may be random or periodic. Research has indicated that certain communication channels are subject to different types of noise distribution. To support a variety of channel types, with different noise distributions, an arbitrary waveform generator (AWG) is used to source impulse noise into the channel. The preferred embodiment of the burst noise generator of step 220 (See FIG. 22) is shown in FIG. 26. The basis of the burst noise generator 220 (See FIG. 22) is an AWG consisting of user programmable memory 234 (See FIG. 26), and an address generator 236 (See FIG. 26) which can sequentially access memory locations resulting in memory contents being added to the contents of the channel. The number of memory locations and the content of those locations which are used to represent the burst noise can be determined by the user through the graphical user interface.

The AWG will sequentially step through the memory addresses, outputting the memory content into an adder circuit at the rate of the channel simulator signal representation. For high-speed operations, the memory contents may be multiplexed to slow the memory access requirements allowing for more storage of points from the same memory, or the use of memory with a slower access time than the period time of the channel. The sequential memory access continues until the address generator 236 (See FIG. 26) has incremented up to the user defined end of the burst waveform. The start of the address generator 236 (See FIG. 26) incremental address generation is caused by a trigger timer 238 (See FIG. 26) which is user programmable through the use of a graphical user interface. The trigger timer 238 (See FIG. 26) can be set to trigger at periodic intervals, or randomly when the address generator is inactive.

Spectrum Analyzer (SA)

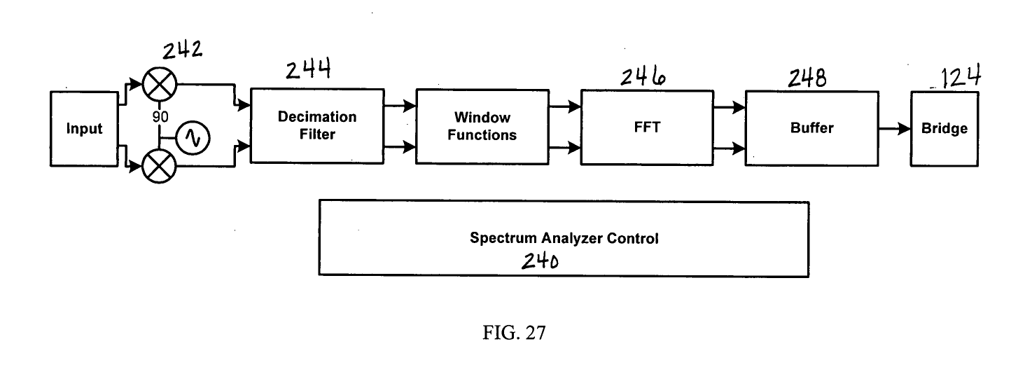

The present invention can be configured to support spectral analysis of a signal by implementing the signal chain shown in FIG. 27 with a spectrum analyzer 240 (See FIG. 27). The input is taken from either the HSIO port 134 (See FIG. 1), channel simulator system (CSS) 198 (See FIG. 22) output, ADC output, or the output from a functional block implemented in the DSPS 126 which forms a communications function. The DSPH portions of the spectrum analyzer (SA) 240 (See FIG. 27) consist of a frequency translation function 242 (See FIG. 27), a low pass filter 244 (See FIG. 27), a fast Fourier transform (FFT) 246 (See FIG. 27), and a buffer 248 (See FIG. 27) to hold the results of the transform. The frequency translation function produces a carrier and mixes the carrier with the input signal to produce an image of the input signal near DC (baseband). The baseband representation of the spectrum is filtered with a FIR filter to reject the image signals created by the conversion process, and provide the IF bandwidth functionality expected of a spectrum analyzer. The FIR filter may additionally decimate the input signal to reduce the number of samples passed to the FFT based on selections the user makes on data rate and bandwidth via the user interface. The windowing function applies window shapes (Blackmon, Hanning, boxcar, etc.) to the incoming samples. The window function is chosen by the user through the GUI. The FFT performs a butterfly transform on the data to produce a frequency representation of the time domain input signal. The results of the FFT operation are periodically transferred to the buffer for additional processing, or transmission to the MPS 102 (See FIG. 1) through the bridge 124.

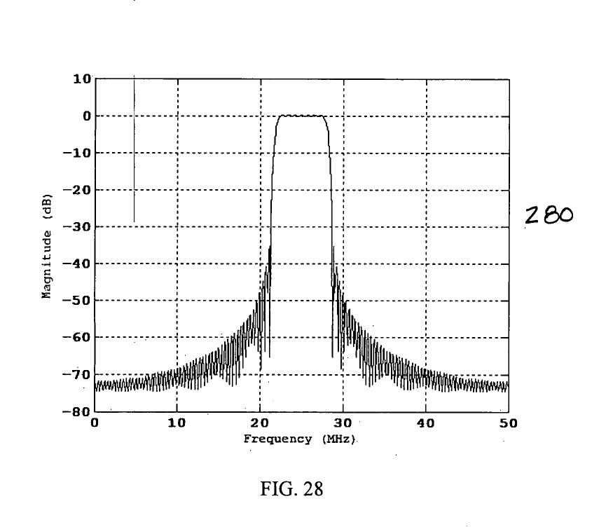

The MPS 102 (See FIG. 1) processes the data received across the bridge 124 from the buffer in the DSPS 126 (See FIG. 1), and formats a visual representation of the spectrum. This formatting includes calculating the amplitude in decibels of the respective frequency bins, and assigning the proper frequency to each bin. This visual representation is displayed on the front panel display an example of which is shown in FIG. 28. Data from the spectral analysis is also made available in tabular form for the user, and can be saved to file for later retrieval.

Oscilloscope

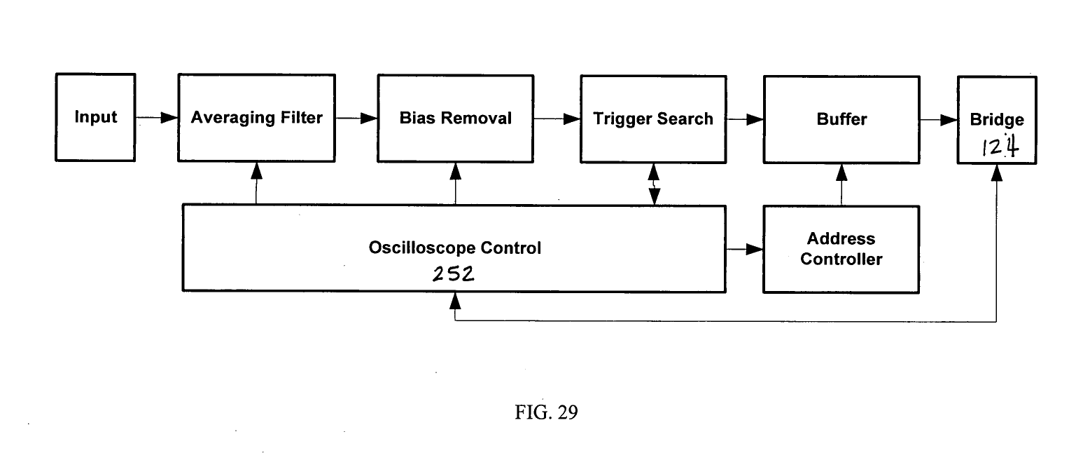

The oscilloscope mode 252 (See FIG. 29) is supported for signals present at the boundary of any block in the DSPS 126 (See FIG. 1). The function of the system in the oscilloscope mode is similar to the function of stand-alone oscilloscopes. A waveform representation of data is produced on the system display, in amplitude versus time format.

Logic Analyzer

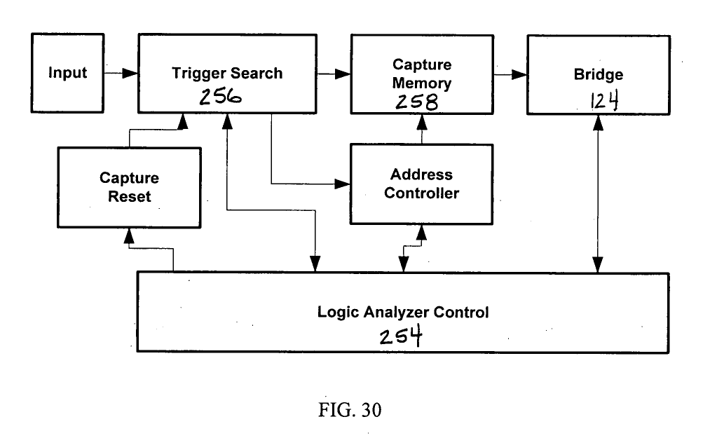

The logic analyzer mode 254 (See FIG. 30) is supported for signals present at the boundary of most blocks in the DSPS 126 (See FIG. 1). The function of the system in the logic analyzer mode 254 (See FIG. 30) is similar to the function of a stand-alone logic analyzer, but the invention can support several important additions not found on traditional logic analyzers.

A logic analyzer 254 (See FIG. 30) is used to capture digital data for display or analysis. The logic analyzer 254 (See FIG. 30) is configured to trigger on a particular pattern in the digital data, and perform some action when the trigger is encountered at step 256 (See FIG. 30). Usually this trigger denotes the start, stop, or midpoint of a data capture. Captured data is stored to a high speed memory (HSM) resource for processing after the trigger event at step 258 (See FIG. 30). The captured data is processed and then displayed as words, bits, or time domain waveforms through the system display. The functionality of a traditional logic analyzer ends at these functions. Typically further processing of the data would require transferring the data to a computer for manual analysis with third-party software tools.

The present invention provides the functionality of traditional logic analyzers, and extends these capabilities in the following ways. First the logic analyzer as implemented in the present invention is used primarily for the physical digital interface and acquisition techniques which make current logic analyzers easy to use and versatile. Once the captured data is within the invention, the remainder of the DSPS 126 (See FIG. 1) can act upon that data in ways which are particular to the user's application. For example, the logic analyzer as implemented in the invention may display the digital information in the frequency domain, by passing the captured data to other subsystems such as the spectrum analyzer 240 (See FIG. 27) or a receiver chain, or another specific digital signal processing configuration.

Arbitrary Waveform Generator/Pattern Generator

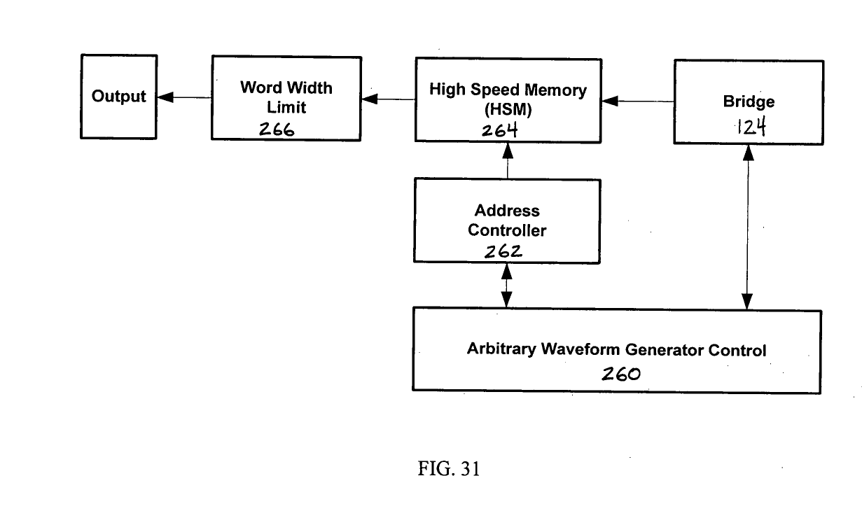

An arbitrary waveform generator (AWG) 260 (See FIG. 31) and pattern generator mode provides a means to apply arbitrary stimulus to the HSIO 134 (See FIG. 1), or to DSPS 126 (See FIG. 1) blocks. The generator system is based upon deep HSM resources 264 (See FIG. 31) which are populated with waveform amplitude information by the MPS 102 (See FIG. 1). The generator reads the values of the HSM memory locations, and provides the contents of the locations to either a DSPS 126 (See FIG. 1) block or the HSIO 134 (See FIG. 1). The waveform amplitude information is accessed in sequential order with a rate of access controlled by the address controller 262 and AWG controller 260 as shown in FIG. 31. The generator can act as a true AWG by routing the contents of the memory to the DAC resource for waveform reconstruction. Conversely, the generator can function as a pattern generator by keeping the waveform amplitude information in a purely digital form. The generator features a word-width limiting block at 266 (See FIG. 31) to reduce the required bandwidth and precision of the generator output when the resources for conveying the full word width of the HSM resource are not needed. This enables simple interfacing to bit-limited resources like a DAC.

Data Source

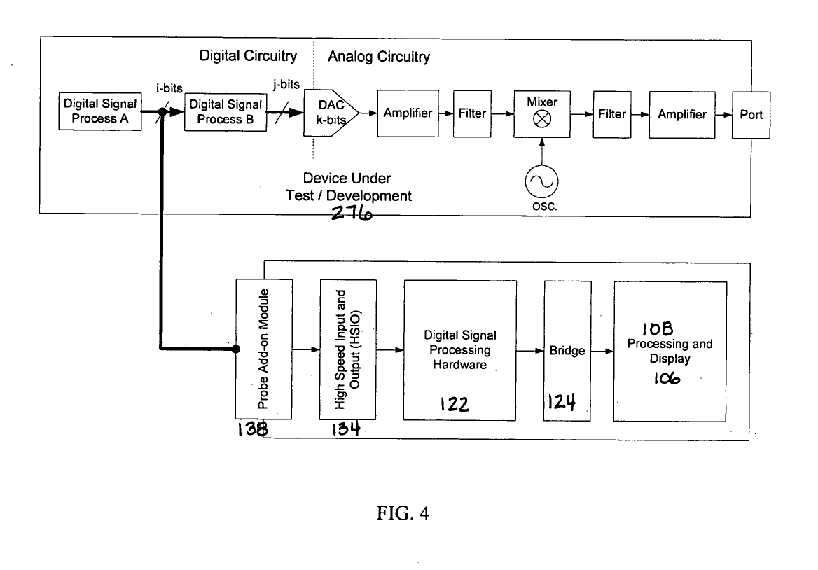

The present invention can be configured to act as a data source for digital signal processing systems 126 (See FIG. 1). As a data source, the present invention can provide randomized data, processed data, or pre-defined encoded data patterns to a device under test (DUT) 276 (See FIG. 4). The data source can be configured to route data to a DUT 276 (See FIG. 4) or to signal processing blocks in the DSPS 126 (See FIG. 1). This allows the present invention to provide known data sets to a DUT 276 (See FIG. 4) for development purposes. For the data source feature the system may be connected to the DUT 276 (See FIG. 4) as shown in FIG. 4.

The data is sourced either by using GLR 174 (See FIG. 17) or MPS 102 (See FIG. 1) resources to generate and process data. Several options exist for sourcing the data. Data may be sourced from the MSS 104 (See FIG. 1) where it has been stored by the factory or user in a format compatible with a particular application. Additionally data may be sourced by pseudo random bit sequence (PRBS) generators implemented in the GLR 174 (See FIG. 17). Further options for data sourcing may include complex operations related to particular applications, such as error-encoding, data framing, interleaving, JPEG encoding, or other application specific data operations. These operations may be implemented in the MPS 102 (See FIG. 1) or the GLR 174 (See FIG. 17).

Standards Based Systems

In order to facilitate testing of particular classes of DUTs 276 (See FIG. 4) the present invention can be configured to assume a particular operational profile based on recognized consensus standards. This allows the user to easily configure a system with known operational characteristics, for the purpose of developing or testing a DUT 276 (See FIG. 4) in accordance with the consensus standard. The profile is loaded and configured through the system GUI. The standards based profile configures the DSPS 126 (See FIG. 1) to implement the targeted standard.

Standards based profiles may include image processing systems, communications systems, radar processing systems, and other digital signal processing systems. Once a standards based profile is loaded, the present invention can be configured to apply compliant stimulus to the DUT 276 (See FIG. 4). Conversely the present invention may be configured to receive stimulus from the DUT 276 (See FIG. 4), and report on the state of the stimulus with respect to the standards definitions. The present invention allows developers to build components which implement portions of the specification, and test those components individually with inputs and outputs defined in the standard. This functionality enables co-development of standards based system components, and can minimize component redesign and system integration efforts. The flexible nature of the present invention allows for support of present and future standards based systems, through modular hardware and software updates.

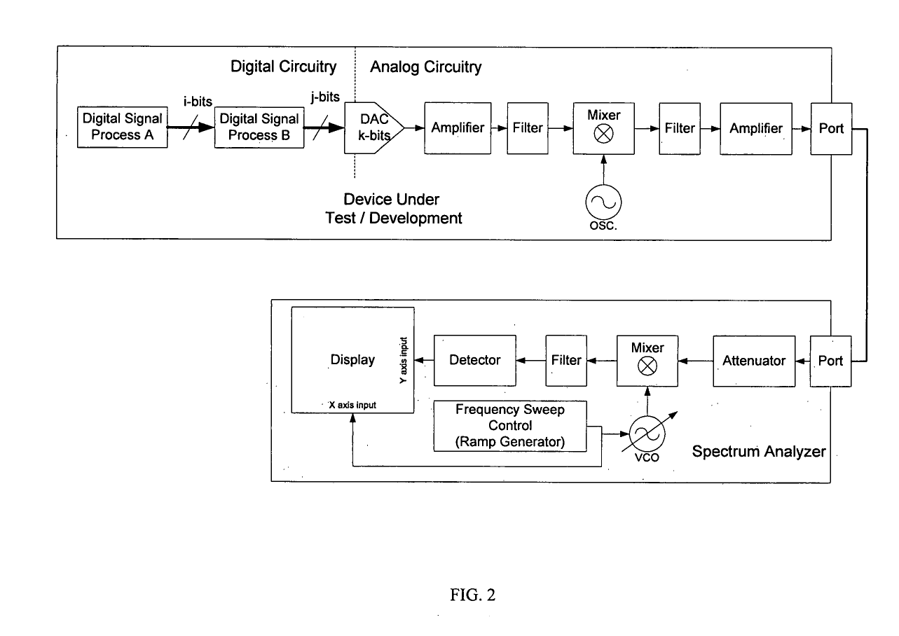

FIG. 2 is a block diagram of prior art connection of spectrum analyzer to device under test (DUT) 276. An understanding of the novelty of the present invention can be gained by comparing the present invention to prior art. The present invention allows designers to interact with their digital signal designs in new ways. This new interaction is enabled by providing a method to connect to digital signal processing hardware, and provide signal analysis and presentation that has previously been only available in equipment via analog interface.

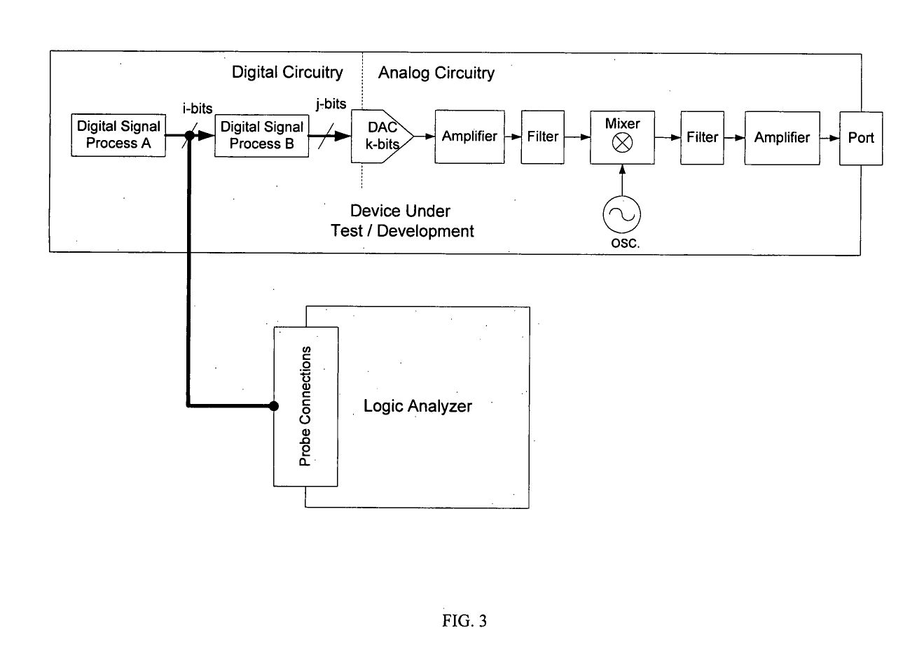

For example, digital filtering is one of the most popular applications for digital signal processing systems. A digital filter operates on a series of input samples which are digital representations of a signal. The input samples are processed by the digital filter to produce a set of output values which represent a signal with a different frequency or phase response than the input signal. In the case of the digital filter, both the input and the output signals are digital and can be measured with equipment such as a logic analyzer 284 (See FIG. 3). The logic analyzer 284 (See FIG. 3) displays time domain relationships of the input and output signals, but it does not display the frequency domain relationship of the digital filter. As most filter designers express design goals and critical parameters in the frequency domain, the logic analyzer approach leaves the designer with minimal information on the performance of the filter design. The filter designer may turn to frequency analysis equipment such as a spectrum analyzer 286 (See FIG. 2) to display the frequency dependant characteristics of the filter design. Unfortunately spectrum analyzers require analog inputs which must fall between certain frequencies in order to operate on the signal and display the filter frequency information. This requires the addition of digital and analog circuitry at the output of the digital filter to transform the digital filter output signal into an analog signal compatible with the spectrum analyzer 286 (See FIG. 2).

In the course of performing these transformations, noise and distortion are added to the original signal, masking the performance of digital filter. The present invention overcomes these limitations by providing a logic analyzer-like physical interface which allows connection of the present invention to digital signals, and a processing system which can extract time-domain, frequency domain, phase domain, or specialty signal processing data representations from the digital signals. There are several differences in connection methods between the logic analyzer 284 (See FIG. 3) and spectrum analyzer 286 (See FIG. 2) of the prior art and the present invention.

Further, let us assume that the block labeled “Digital Signal Process A” 288 (See FIG. 2) represents the digital filter under test. Let us also assume that the digital filter is part of a chain of DSP blocks which collectively serve to transmit data across a wireless link. With these two assumptions, it is reasonable to expect that the user will be interested in the frequency response of the filter as well as the effect the filter has on the transmitted data. To illustrate the improvement the present invention offers over conventional technology, we recall that the logic analyzer 284 (See FIG. 3) and the present invention share the same connection abilities, but different processing capabilities. The logic analyzer 284 (See FIG. 3) is the only practical prior art test gear capable of connecting to the “digital signal process A” block. In terms of connection, the present invention does not offer novel technologies over the present day logic analyzer 284 (See FIG. 3).

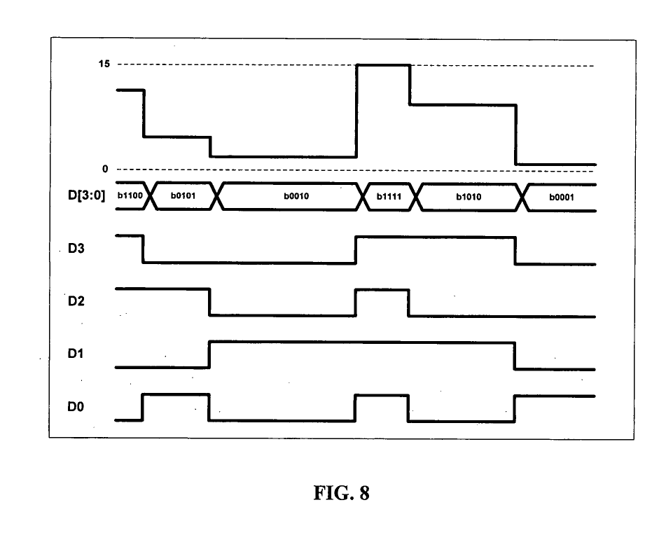

However, to illustrate the differences in processing capabilities, an example of a logic analyzer 284 (See FIG. 3) display in FIG. 8 can be compared to a display of the same information on the present invention in FIG. 9. The display of the present invention is extensible to show the frequency domain representation of the data, as well as specialized modes of display which may be enabled for certain types of input data, such as the constellation diagram also displayed in FIG. 9. These extended display and analysis modes are made possible by configuring the present invention's generic logic resources (GLR) 174 (See FIG. 17) to perform the specialized processing needed to extend simple time-domain information into more complex representations. In this example, the designer can now view the digital filter frequency response and the affect of the filter on the transmitted data as the data would appear at the receiver by using the constellation display mode.

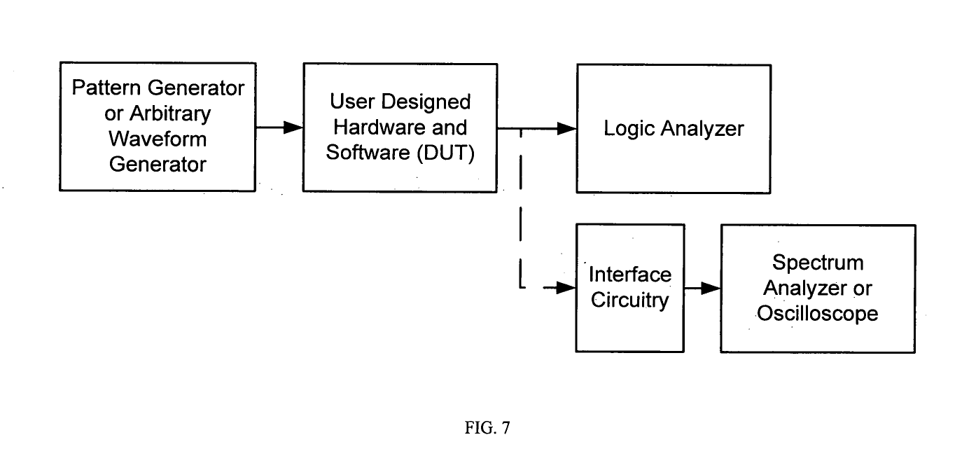

The present invention allows other novel modes of operation. One such mode aids digital signal designers with the development of algorithms, processes, and hardware. In this configuration, the designer interposes a device under test (DUT) 276 (See FIG. 4) between a data source and a data sink. Configurations which allow this development are shown as prior art in FIG. 7. In prior art, the DUT 290 (See FIG. 7) may consist of custom hardware from the designer, and software executing on the hardware. The DUT 290 (See FIG. 7) receives data from equipment such as a pattern generator or arbitrary waveform generator (AWG) 292 (See FIG. 7). The DUT hardware and software operate on the sourced data and outputs the results to some kind of measurement equipment. Typically this equipment would be a logic analyzer 284 (See FIG. 7), or oscilloscope 293 (See FIG. 7), or spectrum analyzer 286 (See FIG. 7). The short comings of the logic analyzer 284 (See FIG. 7) and spectrum analyzer 286 (See FIG. 7) in many digital signal processing tasks have been demonstrated previously. Oscilloscopes have shortcomings in terms of quantifying DSP systems as well. Oscilloscopes are inherently analog interfaced devices that typically lack an adequate number of channels to observe a group of parallel data signals larger than a few bits, and extract a coherent meaning from the signals. While the prior art does allow for development of hardware and software on the DUT platform, it does not present an optimal solution for this development because the equipment involved in the sourcing and sinking may not be fully compatible with each other or the DUT.

Additionally, the limitations of the prior art equipment with respect to digital signal processing may constrain the usefulness of the entire system for purposes of development, by requiring additional circuitry on the DUT 290 (See FIG. 7) to enable interface with the prior art test equipment. The present invention addresses the shortcomings of the prior art by providing a platform which combines data movement and control into a single device ensuring compatibility and interoperability between components. Additionally, the processing abilities of the present invention are more suited to digital signal development than the prior art equipment, allowing for a richer feature set to aid the designer in development efforts. The economics of the present invention are likely to offer an additional benefit in such examples, as several pieces of equipment must be used in the prior art to produce results comparable, but inferior, to the present invention. These pieces of equipment would likely require a third party software application and hardware interface to coordinate the interaction of the source, DUT, and sink, instead of the present invention's approach where the controlling software is already part of the invention, and the hardware interface is inherently digital and therefore DSP compatible.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

We claim:

1. An apparatus for digital signal processing (DSP) comprising:
a main processor system;
digital signal processing hardware connected through a bridge to said main processor system;
a processor subsystem positioned within said main processor system to receive input;
at least one input device for providing said input;
a display subsystem interfaced with said processor subsystem to present information to a user;
a graphical user interface associated with said display subsystem for presenting information to a user;
generic logic resources housed within said digital signal processing hardware which implement the digital signal processing;
digital signal processing system circuitry which supports the digital signal processing functions, wherein said circuitry includes memory and bridge circuitry;
at least one high speed input output port connected to said digital signal processing system circuitry;
at least one digital to analog converter connected to said digital signal processing system circuitry;
at least one analog to digital converter connected to said digital signal processing system; and
at least one add on module connected to said digital signal processing system circuitry to extend the capabilities of the digital signal processing system.

2. The apparatus for digital signal processing (DSP) of claim 1 wherein said add on module is a probe interface add on module.

3. The apparatus for digital signal processing (DSP) of claim 1 wherein said add on module is a field programmable gate array development add on module.

4. The apparatus for digital signal processing (DSP) of claim 1 wherein said add on module is a DSP processor development add on module.

5. The apparatus for digital signal processing (DSP) of claim 1 wherein said add on module is a radio frequency interface add on module.

6. The apparatus for digital signal processing (DSP) of claim 1 wherein said add on module is an electronics development add on module.

7. The apparatus for digital signal processing (DSP) of claim 1 further comprising a quadrature transmitter associated with said generic logic resources.

8. The apparatus for digital signal processing (DSP) of claim 1 further comprising a quadrature receiver associated with said generic logic resources.

9. The apparatus for digital signal processing (DSP) of claim 1 further comprising a channel simulator associated with said graphical user interface.

10. The apparatus for digital signal processing (DSP) of claim 1 further comprising a spectrum analyzer associated with said digital signal processing hardware.

11. The apparatus for digital signal processing (DSP) of claim 1 further comprising a logic analyzer associated with said digital signal processing hardware.

12. The apparatus for digital signal processing (DSP) of claim 1 further comprising an arbitrary waveform generator associated with said digital signal processing hardware.

13. An apparatus for processing digital signals and displaying information pertaining to the digital signals without the requirement that the digital signals be previously represented as analog signals comprising:
a high speed digital interface;
an add on module connected to said high speed digital interface;
user equipment connected to said add on module;
digital signal processing hardware connecting to said high speed digital interface;
a configuration loaded onto said digital signal processing hardware to process digital signals whereby said digital signal processing hardware processes the digital signals in real time to produce processed data;
a means to store said processed data associated with said digital signal processing hardware; and
a means to display said processed data to a user whereby said means to display is associated with said digital signal processing hardware.

14. The apparatus for processing digital signals and displaying information pertaining to the digital signals without the requirement that the digital signals be previously represented as analog signals of claim 13 said apparatus further comprising:
a means for extracting frequency domain information from the digital signals;
additional configurations loaded onto said digital signal processing hardware to permit said digital signal processing hardware to perform fast Fourier transforms on the digital signals; and
a graphical user interface for formatting and display of the results of the fast Fourier transforms whereby said graphical user interface conveys amplitude versus frequency relationship of the digital signal.

15. The apparatus for processing digital signals and displaying information pertaining to the digital signals without the requirement that the digital signals be previously represented as analog signals of claim 13 wherein said digital signal processing hardware is configured as a quadrature receiver with digital input from said high speed digital interface, said digital signal processing hardware further comprising additional configuration of said digital signal processing hardware to perform operations for carrier synchronization, local oscillator generation, matched filter application, adaptive filter application, sample rate reduction; symbol timing recovery, symbol decision, and constellation demapping, said operations performed on a quadrature component or inphase component of the digital signal whereby the results of said operations are made available for display by a graphical user interface and are made available for further processing.

16. The apparatus for processing digital signals and displaying information pertaining to the digital signals without the requirement that the digital signals be previously represented as analog signals of claim 15 wherein the results of said operations are displayed as a constellation diagram which plots the in-phase versus quadrature-phase portions of the digital signal on separate axes.

17. The apparatus for processing digital signals and displaying information pertaining to the digital signals without the requirement that the digital signals be previously represented as analog signals of claim 15 wherein the results of said operations are displayed to the user in the form of statistics about the received signal.

18. The apparatus for processing digital signals and displaying information pertaining to the digital signals without the requirement that the digital signals be previously represented as analog signals of claim 13 wherein said add on module extends the functionality of said apparatus.

19. The apparatus for processing digital signals and displaying information pertaining to the digital signals without the requirement that the digital signals be previously represented as analog signals of claim 18 wherein said add on module further comprises:
an add on module assembly; and
an analog to digital converter positioned on said add on module assembly, said analog to digital converter further comprising an output and an input, said output connected to said high speed digital interface and said input connected to an external connector.

20. The apparatus for processing digital signals and displaying information pertaining to the digital signals without the requirement that the digital signals be previously represented as analog signals of claim 18 wherein said add on module further comprises:
an add on module assembly; and
an analog to digital converter positioned on said add on module assembly, said analog to digital converter further comprising an output and an input, said output connected to said high speed digital interface and said input connected to frequency translation circuitry whereby said frequency translation circuitry converts radio frequency signals to signals compatible with said analog to digital converter input and whereby said frequency translation circuitry comprises an input connected to an external connector.

21. The apparatus for processing digital signals and displaying information pertaining to the digital signals without the requirement that the digital signals be previously represented as analog signals of claim 18 wherein said add on module further comprises:
an add on module assembly; and
a digital to analog converter positioned on said add on module assembly, said digital to analog converter further comprising an output and an input, said output connected to an external connector and said input connected to said high speed digital interface.

22. The apparatus for processing digital signals and displaying information pertaining to the digital signals without the requirement that the digital signals be previously represented as analog signals of claim 18 wherein said add on module further comprises:
an add on module assembly; and
a digital to analog converter positioned on said add on module assembly, said digital to analog converter further comprising an output and an input, said input connected to said high speed digital interface and said output connected to frequency translation circuitry whereby said frequency translation circuitry converts the digital to analog converter output to radio frequency and whereby said frequency translation circuitry comprises an output connected to an external connector.

23. The apparatus for processing digital signals and displaying information pertaining to the digital signals without the requirement that the digital signals be previously represented as analog signals of claim 13 wherein said digital signal processing hardware is configured as a communications channel simulator interposed between a transmitter and a receiver, whereby said configuration as a communications channel simulator subjects the digital signals to impairments, said apparatus further comprising:
an add on module assembly;
said add on module assembly connected to a digital signal source on said transmitter to obtain a user supplied digital signal, said add on module assembly connected to a digital signal sink in said receiver and said add on module assembly connected to an ouput of said digital signal processing hardware; and
a graphical user interface for display of information to the user.

24. The apparatus for processing digital signals and displaying information pertaining to the digital signals without the requirement that the digital signals be previously represented as analog signals of claim 13 wherein said user equipment is connected to connection bypassing analog circuitry.

25. The apparatus for processing digital signals and displaying information pertaining to the digital signals without the requirement that the digital signals be previously represented as analog signals of claim 24 wherein said user equipment is connected to connection bypassing analog circuitry whereby the connection point is at an input to a digital to analog converter on said user equipment.

26. The apparatus for processing digital signals and displaying information pertaining to the digital signals without the requirement that the digital signals be previously represented as analog signals of claim 24 wherein said user equipment is connected to connection bypassing analog circuitry whereby the connection point is at an output of an analog to digital converter on said user equipment.

27. The apparatus for processing digital signals and displaying information pertaining to the digital signals without the requirement that the digital signals be previously represented as analog signals of claim 23 wherein said digital signal processing hardware is implemented entirely with digital circuitry.

28. The apparatus for processing digital signals and displaying information pertaining to the digital signals without the requirement that the digital signals be previously represented as analog signals of claim 23 wherein said digital signal processing hardware maintains a dynamic range from input to output of at least 160 dB.

29. The apparatus for processing digital signals and displaying information pertaining to the digital signals without the requirement that the digital signals be previously represented as analog signals of claim 23 wherein said digital signal processing hardware simulates white noise from a user supplied digital signal, a portion of said digital signal processing hardware configured as a pseudo random noise source whereby said noise source is controllable in amplitude and can be added to the user supplied digital signal and whereby said digital signal processing hardware has a dynamic range to model the user supplied digital signal in addition to the signal from said random noise source when the noise signal is at least −150 dB below full scale.

30. The apparatus for processing digital signals and displaying information pertaining to the digital signals without the requirement that the digital signals be previously represented as analog signals of claim 23 wherein said digital signal processing hardware simulates multi-path interference from a user supplied digital signal, wherein said digital signal processing hardware comprises:
a plurality of buffers containing copies of the user supplied digital signal;
an output of said buffers delayed in time and summed with said user supplied digital signal; and
a graphical user interface associated with said buffers to configure the relative delay between buffers.

31. The apparatus for processing digital signals and displaying information pertaining to the digital signals without the requirement that the digital signals be previously represented as analog signals of claim 23 wherein said digital signal processing hardware simulates burst noise channel impairments from a user supplied digital signal, wherein said digital signal processing hardware further comprises:
outputs of one or more pattern generators or the digital representation of arbitrary waveform generators providing burst noise impairments whereby said outputs are configurable in amplitude, duration, and rate of repetition and summed with the user supplied digital signal to produce an impaired signal, said impaired signal routed to the remaining portions of digital signal processing hardware or to said high speed digital interface.

32. The apparatus for processing digital signals and displaying information pertaining to the digital signals without the requirement that the digital signals be previously represented as analog signals of claim 23 wherein said digital signal processing hardware simulates jamming impairments from a user supplied digital signal, wherein said digital signal processing hardware further comprises:
at least one jamming impairment source, said jamming impairment source being supplied by the output of at least one numerically controlled oscillators, said output of said at least one numerically controlled oscillators being added to the user supplied digital signal whereby said output is controllable in frequency, phase, amplitude, duration and modulation, said digital signal processing hardware having sufficient dynamic range to represent the user supplied digital signal and the jamming impairments for impairments of at least 30 dB greater than the level of a digital signal carrier.

33. The apparatus for processing digital signals and displaying information pertaining to the digital signals without the requirement that the digital signals be previously represented as analog signals of claim 23 wherein said digital signal processing hardware further comprises a digital filter applied to the user supplied digital signal, whereby said digital filter has frequency selectivity to simulate frequency selective fading.

34. The apparatus for processing digital signals and displaying information pertaining to the digital signals without the requirement that the digital signals be previously represented as analog signals of claim 13 wherein said digital signal processing hardware further comprises additional configuration to process communications signals to extracted information for vector signal analysis, said extracted information being displayed by a graphical user interface or stored in memory.

35. The apparatus for processing digital signals and displaying information pertaining to the digital signals without the requirement that the digital signals be previously represented as analog signals of claim 13 wherein said digital signal processing hardware is configured as a quadrature transmitter, said digital signal processing hardware further comprising additional configuration of said digital signal processing hardware to perform operations for data whitening, carrier synchronization, local oscillator generation, matched filter application, adaptive filter application, sample rate reduction, symbol timing generation, symbol decision, and constellation mapping, said operations performed on an inphase component or a quadrature component of the digital signal whereby the results of said operations are made available for display by a graphical user interface and routed to said high speed digital interface for transmission by way of said add on module.

36. The apparatus for processing digital signals and displaying information pertaining to the digital signals without the requirement that the digital signals be previously represented as analog signals of claim 13 wherein said digital signal processing hardware is configured as a quadrature transceiver.
